(19) United States
(12) Patent Application Publication
(10) Pub. No.: US 2016/0119639 A1
(43) Pub. Date: Apr. 28, 2016

(54) IMAGE PROCESSING APPARATUS AND IMAGE PROCESSING METHOD

(71) Applicant: Sony Corporation, Tokyo (JP)

(72) Inventor: Kazushi SATO, Kanagawa (JP)

(73) Assignee: SONY CORPORATION, Tokyo (JP)

(21) Appl. No.: 14/378,714

(22) PCT Filed: Feb. 28, 2013
(86) PCT No.: PCT/JP2013/055387

§ 371 Date: Aug. 14, 2014

(30) Foreign Application Priority Data
Apr. 20, 2012 (JP) 2012-097044
Dec. 17, 2012 (JP) 2012-274470

(51) Int. Cl. H04N 19/52; H04N 19/103; H04N 19/593; H04N 19/176; H04N 19/30; H04N 19/463; H04N 19/159

(52) U.S. Cl. CPC H04N 19/52; H04N 19/463; H04N 19/103; H04N 19/159; H04N 19/176; H04N 19/30; H04N 19/593

(57) ABSTRACT

Provided is an image processing apparatus including a base layer prediction section that generates a predicted image for a first block in a base layer decoded by a first encoding method in a prediction mode specified by prediction mode information from a first prediction mode set, and an enhancement layer prediction section that generates the predicted image for a second block corresponding to the first block in an enhancement layer decoded by a second encoding method having a second prediction mode set that is different from the first prediction mode set in a prediction mode selected from the second prediction mode set based on the prediction mode specified for the first block.

### TECHNICAL FIELD

The present disclosure relates to an image processing apparatus and an image processing method.

### BACKGROUND ART

The standardization of an image coding scheme called HEVC (High Efficiency Video Coding) by JCTVC (Joint Collaboration Team-Video Coding), which is a joint standardization organization of ITU-T and ISO/IEC, is currently under way for the purpose of improving coding efficiency more than H.264/AVC. For the HEVC standard. Committee draft as the first draft specifications was issued in February, 2012 (see, for example, Non-Patent Literature 1 below).

Encoding a base layer in scalable video coding by a conventional image encoding method and encoding an enhancement layer in HEVC to enable decoding of an encoded stream by different image encoding methods is proposed (see, for example, Non-Patent Literature 2 below).

Incidentally, scalable video coding (SVC) is generally a technology that hierarchically encodes a layer transmitting a rough image signal and a layer transmitting a fine image signal. Typical attributes hierarchized in the scalable video coding mainly include the following three:
Space scalability: Spatial resolutions or image sizes are hierarchized.
Time scalability: Frame rates are hierarchized.
SNR (Signal to Noise Ratio) scalability: SN ratios are hierarchized.

Further, though not yet adopted in the standard, the bit depth scalability and chroma format scalability are also discussed.

In scalable video coding, encoding efficiency can be increased by encoding parameters that can be shared between layers only in one layer. In H.264/AVC Annex G SVC, for example, reference image information can be shared between layers.

### CITATION LIST

### Non-Patent Literature

Non-Patent Literature 1: Benjamin Bross, Woo-Jin Han, Jens-Rainer Ohm, Gary J. Sullivan, Thomas Wiegand, “High efficiency video coding (HEVC) text specification draft 6” (JCTVC-H1003 ver. 20, Feb. 17, 2012)
Non-Patent Literature 2: Ajay Luthra, Jens-Rainer Ohm, Joern Ostermann, “Draft requirements for the scalable enhancement of HEVC” (ISO/IEC JTC1/SC29/WG11 N12400, November 2011)

### SUMMARY OF INVENTION

### Technical Problem

When a plurality of layers is encoded by mutually different image encoding methods, however, it becomes difficult to share parameters between layers due to differences of supported modes. For example, a set of prediction supported for the intra prediction and inter prediction is different between a conventional image encoding method such as H.264/AVC (hereinafter, simply called AVC) or MPEG2 and HEVC. However, the intra prediction and inter prediction is originally a technology to reduce the code amount by using spatial correlations or temporal correlations of images and characteristics of such correlations do not significantly change between layers.

Therefore, when a plurality of layers is encoded by different image encoding methods in scalable video coding, the code amount needed for prediction mode information can be reduced by appropriately mapping the prediction mode.

### Solution to Problem

According to the present disclosure, there is provided an image processing apparatus including a base layer prediction section that generates a predicted image for a first block in a base layer decoded by a first encoding method in a prediction mode specified by prediction mode information from a first prediction mode set, and an enhancement layer prediction section that generates the predicted image for a second block corresponding to the first block in an enhancement layer decoded by a second encoding method having a second prediction mode set that is different from the first prediction mode set in a prediction mode selected from the second prediction mode set based on the prediction mode specified for the first block.

The image processing apparatus mentioned above may be typically realized as an image decoding device that decodes an image.

According to the present disclosure, there is provided an image processing method including generating a predicted image for a first block in a base layer decoded by a first encoding method in a prediction mode specified by prediction mode information from a first prediction mode set, and generating the predicted image for a second block corresponding to the first block in an enhancement layer decoded by a second encoding method having a second prediction mode set that is different from the first prediction mode set in the prediction mode selected from the second prediction mode set based on the prediction mode specified for the first block.

According to the present disclosure, there is provided an image processing apparatus including a base layer prediction section that generates a predicted image for a first block in a base layer encoded by a first encoding method in an optimum prediction mode selected from a first prediction mode set, and an enhancement layer prediction section that generates the predicted image for a second block corresponding to the first block in an enhancement layer encoded by a second encoding method having a second prediction mode set that is different from the first prediction mode set in the prediction mode selected from the second prediction mode set based on the prediction mode selected for the first block.

The image processing apparatus mentioned above may be typically realized as an image encoding device that encodes an image.

According to the present disclosure, there is provided an image processing method including generating a predicted image for a first block in a base layer encoded by a first encoding method in an optimum prediction mode selected from a first prediction mode set, and generating the predicted image for a second block corresponding to the first block in an enhancement layer encoded by a second encoding method having a second prediction mode set that is different from the first prediction mode set in the prediction mode selected from the second prediction mode set based on the prediction mode selected for the first block.

### Advantageous Effects of Invention

According to a technology in the present disclosure, when a plurality of layers is encoded by different image encoding methods in scalable video coding, the code amount needed for prediction mode information can be reduced.

### BRIEF DESCRIPTION OF DRAWINGS

FIG. 1 is an explanatory view illustrating scalable video coding.

FIG. 2A is a first explanatory view illustrating a prediction mode set of an intra prediction in AVC.

FIG. 2B is a second explanatory view illustrating a prediction mode set of an intra prediction in AVC.

FIG. 3A is a first explanatory view illustrating a prediction mode set of an intra prediction in AVC.

FIG. 3B is a second explanatory view illustrating a prediction mode set of an intra prediction in AVC.

FIG. 4A is a first explanatory view illustrating the prediction mode set of the intra prediction in HEVC.

FIG. 4B is a second explanatory view illustrating the prediction mode set of the intra prediction in HEVC.

FIG. 5A is a first explanatory view illustrating the prediction mode set of the intra prediction in HEVC.

FIG. 5B is a second explanatory view illustrating the prediction mode set of the intra prediction in HEVC.

FIG. 6 is an explanatory view illustrating an example of mapping of the prediction mode sets of the intra prediction between AVC and HEVC.

FIG. 7 is an explanatory view illustrating narrowing down of a prediction direction in an enhancement layer.

FIG. 8A is an explanatory view illustrating a first example of mapping of the prediction mode sets of the inter prediction between AVC and HEVC.

FIG. 8B is an explanatory view illustrating a second example of mapping of the prediction mode sets of the inter prediction between AVC and HEVC.

FIG. 9 is a block diagram showing a schematic configuration of an image encoding device according to an embodiment.

FIG. 10 is a block diagram showing a schematic configuration of an image decoding device according to an embodiment.

FIG. 11 is a block diagram showing an example of the configuration of a first encoding section and a second encoding section shown in FIG. 9.

FIG. 12 is a block diagram showing an example of the detailed configuration of an intra prediction section shown in FIG. 11.

FIG. 13 is a block diagram showing an example of the detailed configuration of an intra prediction section shown in FIG. 11.

FIG. 14 is a flow chart showing an example of a schematic process flow for encoding according to an embodiment.

FIG. 15A is a flow chart showing an example of a detailed flow of an intra prediction process for the enhancement layer during encoding.

FIG. 15B is a flow chart showing an example of the detailed flow of a motion estimation process for the enhancement layer during encoding.

FIG. 16 is a block diagram showing an example of the configuration of a first decoding section and a second decoding section shown in FIG. 10.

FIG. 17 is a block diagram showing an example of the detailed configuration of an intra prediction section shown in FIG. 16.

FIG. 17 is a block diagram showing an example of the detailed configuration of an inter prediction section shown in FIG. 16.

FIG. 19 is a flow chart showing an example of the schematic process flow for decoding according to an embodiment.

FIG. 20A is a flow chart showing an example of the detailed flow of the intra prediction process for the enhancement layer during decoding.

FIG. 20B is a flow chart showing an example of the detailed flow of the motion compensation process for the enhancement layer during decoding.

FIG. 21 is a block diagram showing an example of a schematic configuration of a television.

FIG. 22 is a block diagram showing an example of a schematic configuration of a mobile phone.

FIG. 23 is a block diagram showing an example of a schematic configuration of a recording/reproduction device.

FIG. 24 is a block diagram showing an example of a schematic configuration of an image capturing device.

FIG. 25 is an explanatory view illustrating a first example of use of the scalable video coding.

FIG. 26 is an explanatory view illustrating a second example of use of the scalable video coding.

FIG. 27 is an explanatory view illustrating a third example of use of the scalable video coding.

FIG. 28 is an explanatory view illustrating a multi-view codec.

### DESCRIPTION OF EMBODIMENT

Hereinafter, preferred embodiments of the present disclosure will be described in detail with reference to the appended drawings. Note that, in this specification and the drawings, elements that have substantially the same function and structure are denoted with the same reference signs, and repeated explanation is omitted.

The description will be provided in the order shown below:

1. Overview

1-1. Scalable Video Coding

1-2. Prediction Mode Set for Base Layer

1-3. Prediction Mode Set for Enhancement Layer

1-4. Mapping of Prediction Mode

1-5. Basic Configuration Example of Encoder

1-6. Basic Configuration Example of Decoder

2. Configuration Example of Encoding Section According to an Embodiment

2-1. Overall Configuration

2-2. Detailed Configuration of Intra Prediction Section

2-3. Detailed Configuration of Inter Prediction Section

3. Process Flow for Encoding According to an Embodiment

4. Configuration Example of Decoding Section According to an Embodiment

4-1. Overall Configuration

4-2. Detailed Configuration of Intra Prediction Section

4-3. Detailed Configuration of Inter Prediction Section

5. Process Flow for Decoding According to an Embodiment

6. Modification

6-1. Extension of Prediction Mode

6-2. Switching in Accordance with Combination of Encoding Methods

7. Application Examples

7-1. Application to Various Products

7-2. Various Uses of Scalable Video Coding

7-3. Others

8. Summary

### 1. Overview

[1-1. Scalable Video Coding]

In the scalable video coding, a plurality of layers, each containing a series of images, is encoded. A base layer is a layer encoded first to represent roughest images. An encoded stream of the base layer may be independently decoded without decoding encoded streams of other layers. Layers other than the base layer are layers called enhancement layer representing finer images. Encoded streams of enhancement layers are encoded by using information contained in the encoded stream of the base layer. Therefore, to reproduce an image of an enhancement layer, encoded streams of both of the base layer and the enhancement layer are decoded. The number of layers handled in the scalable video coding may be any number equal to 2 or greater. When three layers or more are encoded, the lowest layer is the base layer and the remaining layers are enhancement layers. For an encoded stream of a higher enhancement layer, information contained in encoded streams of a lower enhancement layer and the base layer may be used for encoding and decoding. In this specification, of at least two layers having dependence, the layer on the side depended on is called a lower layer and the layer on the depending side is called an upper layer.

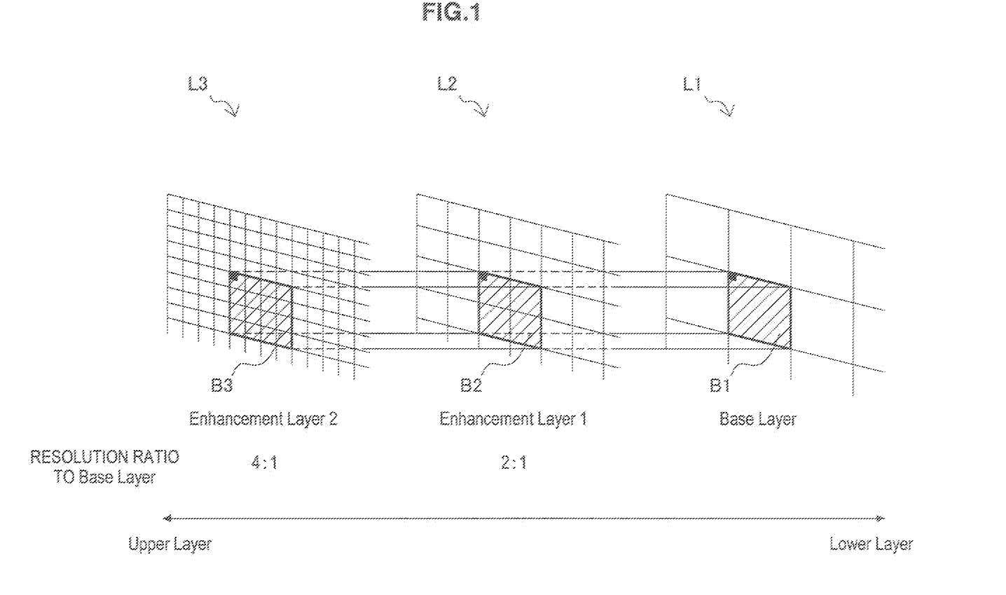

FIG. 1 shows three layers L1, L2, L3 subjected to scalable video coding. The layer L1 is the base layer and the layers L2, L3 are enhancement layers. Here, among various kinds of scalability, the space scalability is taken as an example. The ratio of spatial resolution of the layer L2 to the layer L1 is 2:1. The ratio of spatial resolution of the layer L3 to the layer L1 is 4:1. A block B1 of the layer L1 is a processing unit of a prediction process inside a picture of the base layer. A block B2 of the layer L2 is a processing unit of a prediction process inside a picture of an enhancement layer taking a scene common to the block B1 (in HEVC, the processing unit is referred to as prediction unit). The block B2 corresponds to the block B1 of the layer L1. A block B3 of the layer L3 is a processing unit of a prediction process inside a picture of a higher enhancement layer taking a scene common to the blocks B1 and B2. The block B3 corresponds to the block B1 of the layer L1 and the block B2 of the layer L2.

In such a layer structure, a spatial correlation of an image of some layer is normally similar to spatial correlations of images of other layers corresponding to a common scene. If, for example, the block B1 has a strong correlation with a neighboring block in some direction in the layer L1, it is likely that the block B2 has a strong correlation with a neighboring block in the same direction in the layer L2. Similarly, a temporal correlation of an image of some layer is normally similar to temporal correlations of images of other layers corresponding to a common scene. If, for example, the block B1 has a strong correlation with a reference block in some reference picture in the layer L1, it is likely that the block B2 has a strong correlation with the corresponding reference block in the same reference picture (only in a different layer) in the layer L2. This also applies between the layer L2 and the layer L3.

In the scalable video coding, therefore, prediction mode information of the intra prediction and inter prediction can be shared (reused) between layers by using similarities between layers of correlation characteristics described above. The encoding efficiency is thereby increased. However, when a plurality of layers is encoded by different image encoding methods as proposed in Non-Patent Literature 2 described above, the fact that the supported prediction mode set is not the same could be a common hindrance to sharing of prediction mode information.

It is assumed below as an example that the base layer is encoded in AVC (Advanced Video Coding) and an enhancement layer is encoded in HEVC (High Efficiency Video Coding). However, the technology according to the present disclosure is not limited to such an example and can be applied to other combinations of image encoding methods (for example, the base layer is encoded in MPEG2 and the enhancement layer is encoded in HEVC). That spatial correlations and temporal correlations of an image are similar between layers applies not only to space scalability illustrated in FIG. 1, but also to SNR scalability, bit depth scalability, and chroma format scalability. The technology according to the present disclosure can also be applied to scalable video coding that realizes these kinds of scalability.

Also, some ideas of the technology according to the present disclosure can generally be applied to scalable video coding in which an enhancement layer is encoded in HEVC. In this case, the base layer may be encoded by any encoding method such as AVC, MPEG2, or HEVC.

[1-2. Prediction Mode Set for Base Layer]

(1) Intra Prediction

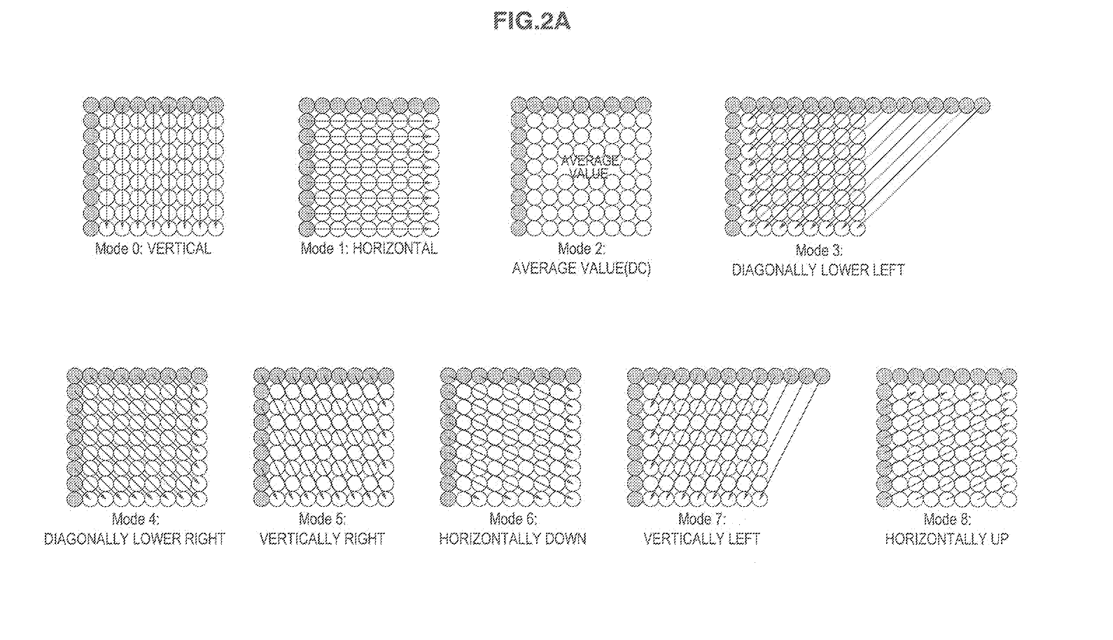

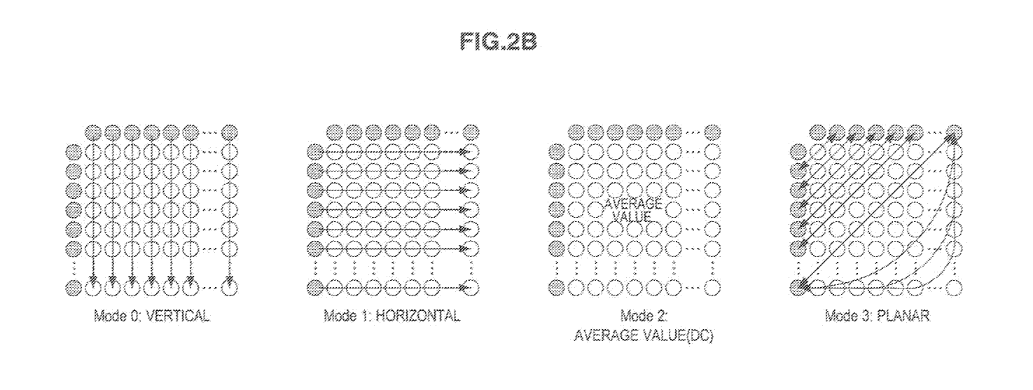

A prediction mode set of an intra prediction in AVC will be described using FIGS. 2A and 2B.

Referring to FIG. 2A, nine prediction modes (Mode 0 to Mode 8) that can be used for a prediction block of the luminance component having the size of 4×4 pixels or 8×8 pixels are shown in AVC. The prediction direction in Mode 0 is vertical. The prediction direction in Mode 1 is horizontal. Mode 2 represents a DC prediction. The prediction direction in Mode 3 is diagonally lower left. The prediction direction in Mode 4 is diagonally lower right. The prediction direction in Mode 5 is vertically right. The prediction direction in Mode 6 is horizontally down. The prediction direction in Mode 7 is vertically left. The prediction direction in Mode 8 is horizontally up. The DC prediction corresponds to a so-called average value prediction and is a prediction mode in which an average value of pixel values of a plurality of reference pixels is used as a predicted pixel value. Eight prediction modes other than the DC prediction are each associated with particular prediction directions. The angular resolution in the prediction direction is 22.5.

Referring to FIG. 2B, four prediction modes (Mode 0 to Mode 3) that can be used for a prediction block of the luminance component having the size of 16×16 pixels are shown in AVC. The prediction direction in Mode 0 is vertical. The prediction direction in Mode 1 is horizontal. Mode 2 represents the DC prediction. Mode 3 represents a planar prediction. The planar prediction is a prediction mode in which the value obtained by interpolation from pixel values of upper and left reference pixels as a predicted pixel value. Also for an intra prediction block of the color difference component, though the mode number is different, four prediction modes shown in FIG. 2B can be selected.

(2) Inter Prediction

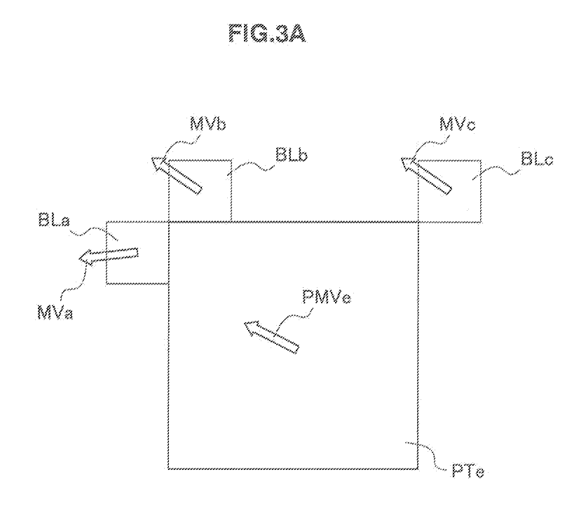

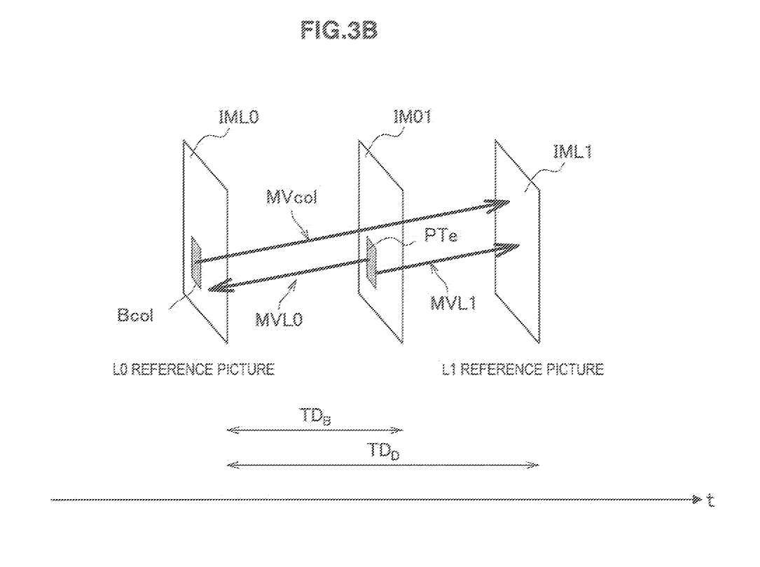

Next, the prediction mode set of an inter prediction in AVC will be described using FIGS. 3A and 3B.

In an inter prediction (motion compensation) in AVC, the reference image number and a motion vector can be determined for each prediction block having a block size selected from seven sizes of 16×16 pixels, 16×8 pixels, 8×16 pixels, 8×8 pixels, 8×4 pixels, 4×8 pixels, and 4×4 pixels. Then, a motion vector is predicted to reduce the code amount of motion vector information.

Referring to FIG. 3A, three neighboring blocks BLa, BLb, BLc adjacent to a prediction block PTe are shown. Motion vectors set to these neighboring blocks BLa, BLb, BLc are set as motion vectors MVa, MVb, MVc respectively. A predicted motion vector PMVe for the prediction block PTe can be calculated from the motion vectors MVa, MVb, MVc by using a prediction formula as shown below:

[Math. 1]

PMVe=med(MVa,MVb,MVc) (1)

Here, med in Formula (1) represents a median operation. That is, according to Formula (1), the predicted motion vector PMVe is a vector having a median value of horizontal components of the motion vectors MVa, MVb, MVc and a median value of vertical components thereof. When any of the motion vectors MVa, MVb, MVc does not exist because, for example, the predicted motion vector PMVe is positioned at the edge of an image, a non-existent motion vector may be omitted from the arguments of a median operation. When the predicted motion vector PMVe is determined, a differential motion vector MVDe is further calculated according to the following formula: MVe represents an actual motion vector to be used for motion compensation for the prediction block PTe.

[Math. 2]

MVDe=MVe−PMVe (2)

In AVC, motion vector information representing the differential motion vector MVDe calculated as described above and reference image information can be encoded for each inter prediction block.

To reduce the code amount of motion vector information still further, a so-called direct mode is supported in AVC intended mainly for B pictures. In direct mode, motion vector information is not encoded and motion vector information of a prediction block to be encoded is generated from motion vector information of encoded prediction blocks. The direct mode includes two kinds of mode, a space direct mode and a time direct mode. In space direct mode, for example, the motion vector MVe for the prediction block PTe can be determined as shown the following formula using Formula (1) shown above:

[Math. 3]

MVe=PMVe (3)

FIG. 3B schematically shows an idea of the time direct mode. In FIG. 3B, a reference image IML0 as an L0 reference picture of an image IM01 to be encoded and a reference image IML1 as an L1 reference picture of the image IM01 to be encoded are shown. A block Bcol in the reference image IML0 is a colocated block of the prediction block PTe the image IM01 to be encoded. A motion vector set to the colocated block Bcol is set as MVcol. Also, the distance on the time axis between the image IM01 to be encoded and the reference image IML0 is set as TD_{B} and the distance on the time axis between the reference image IML0 and the reference image IML1 is set as TD_{D}. Then, motion vectors MVL0, MVL1 for the prediction block PTe are determined in time direct mode as shown in the following formulae:

$$\begin{matrix}[ Math . 4 ] \\ MVL 0 = \frac{{TD}_{B}}{{TD}_{D}} MVcol & ( 4 ) \\ MVL 1 = \frac{{TD}_{D} - {TD}_{B}}{{TD}_{D}} MVcol & ( 5 )\end{matrix}$$

In AVC, which of the space direct mode and the time direct mode is available is specified for each slice. Then, whether the direct mode is used is specified for each block.

Further, in AVC, a skip mode can be specified for each block (macro block). In a block (called a skipped macro block) specified to the skip mode, block information (for example, motion information, prediction error data and the like) is not encoded and prediction pixels compensated for using a predicted motion vector are directly used as decoding pixels.

Also in AVC, the direction of (the forward reference or backward reference) of reference images used for motion compensation can be specified for each block. If the specified reference direction is an L0 prediction, a forward prediction is made using L0 reference pictures. If the specified reference direction is an L1 prediction, a backward prediction is made using L1 reference pictures. If the specified reference direction is a bidirectional prediction, a prediction using both L0 reference pictures and L1 reference pictures is made. Incidentally, both of L0 reference pictures and L1 reference pictures may be present in the same direction. No reference direction is specified to a block to which the intra prediction mode or the direct mode is applied or a skipped macro block.

[1-3. Prediction Mode Set for Enhancement Layer]

(1) Intra Prediction

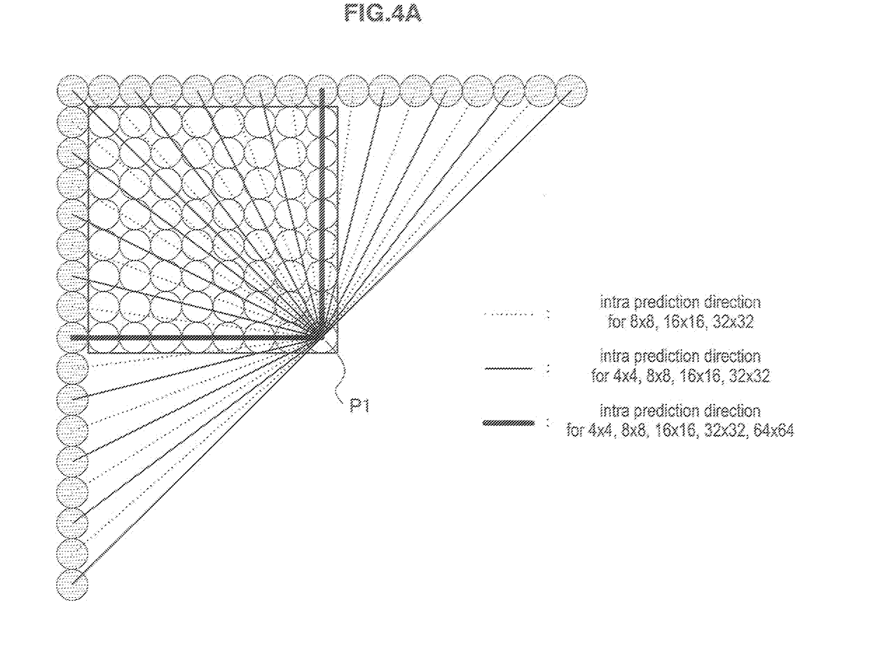

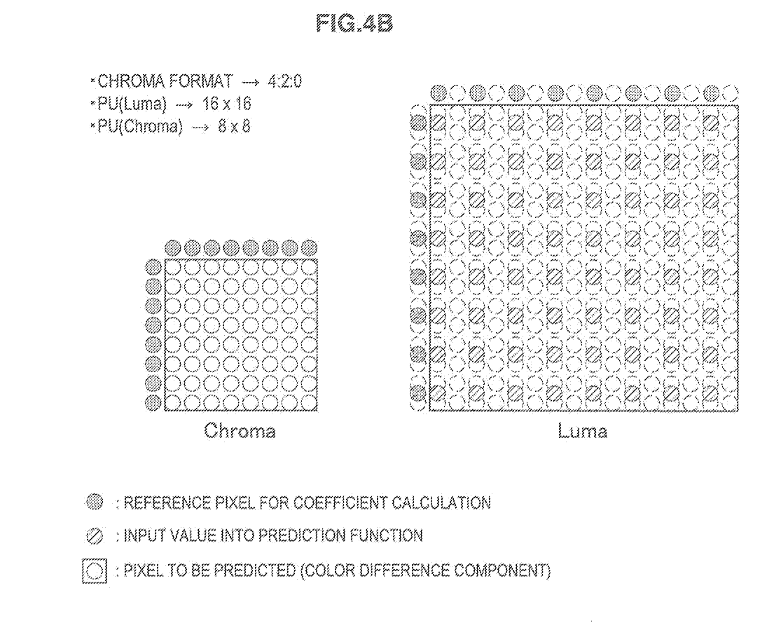

Next, the prediction mode set of the intra prediction in HEVC will be described using FIGS. 4A and 4B.

Also in HEVC, like in AVC, in addition to the DC prediction and planar prediction, a plurality of prediction modes associated with various prediction directions can be used. In the angular prediction in HEVC, however, when compared with AVC, the angular resolution in the prediction direction is enhanced.

FIG. 4A shows prediction direction candidates that can be selected in the angular prediction of HEVC. A pixel P1 shown in FIG. 4A is the pixel to be predicted. Shaded pixels around the block to which the pixel P1 belongs are reference pixels. When the block size is 4×4 pixels, (prediction modes corresponding to) 17 prediction directions connecting reference pixels and the pixel to be predicted indicated by solid lines (both thick and thin lines) in FIG. 4A can be selected (in addition to the DC prediction). When the block size is 8×8 pixels, 16×16 pixels, or 32×32 pixels, (prediction modes corresponding to) 33 prediction directions indicated by dotted lines and solid lines (both thick and thin lines) in FIG. 4A can be selected (in addition to the DC prediction and the planar prediction). When the block size is 64×64 pixels, (prediction modes corresponding to) two prediction directions indicated by thick lines can be selected (in addition to the DC prediction). The angular resolution (angular difference between neighboring prediction directions) is 180 degrees/32=5.625 degrees in the highest case.

Further, in HEVC, a luminance based color difference prediction mode to generate a predicted image of the color difference component based on luminance components in the same block is supported for the prediction unit of the color difference component. In luminance based color difference prediction mode, a linear function having dynamically calculated coefficients is used as a prediction function and thus, the prediction mode is also called a linear model (LM) mode. Arguments of a prediction function are values of luminance components (down-sampled when necessary) and the return value thereof is a predicted pixel value of the color difference component. More specifically, the prediction function in LM mode may be a linear function as shown below:

[Math. 5]

Pr_{C}[x,y]=α·Re_{L}′[x,y]+β (6)

In Formula (6). Re_{L}′(x,y) represents a down-sampled value of the luminance component of a decoded image (so-called reconstructed image). Down-sampling (or phase shifting) of the luminance component may be performed when the density of the color difference component is different from that of the luminance component depending on the chroma format. α and β are coefficients calculated from pixel values of neighboring blocks using a predetermined formula.

If, for example, FIG. 4B is referred to, the prediction unit (PU) of the luminance component (Luma) having the size of 16×16 pixels and PU of the corresponding color difference component (Chroma) when the chroma format is 4:2:0 are conceptually shown. The density of the luminance component is twice that of the color difference component for each of the horizontal direction and the vertical direction. Circles positioned around each PU and filled in, in FIG. 4B, are reference pixels referred to when the coefficients α, β of the prediction function are calculated. Circles diagonally shaded on the right in FIG. 4B are down-sampled luminance components. By substituting values of down-sampled luminance components into the right side Re_{L}′(x,y) of the prediction function, the predicted value of the color difference component in a common pixel position is calculated. When the chroma format is 4:2:0, like the example in FIG. 4B, an input value (value substituted into the prediction function) of one luminance component is generated by down-sampling for each (2×2) luminance components. Reference pixels can also be down-sampled in the same manner.

The coefficients α and β of the prediction function are calculated according to Formula (7) and Formula (8) respectively. I represents the number of reference pixels.

$$\begin{matrix}[ Math . 6 ] \\ α = \frac{I \cdot {\sum }_{i = 0}^{I} {Re}_{C} ( i ) \cdot {Re}_{L}^{′} ( i ) - {\sum }_{i = 0}^{I} {Re}_{C} ( i ) \cdot {\sum }_{i = 0}^{I} {Re}_{L}^{′} ( i )}{I \cdot {\sum }_{i = 0}^{I} {Re}_{L}^{′} ( i ) \cdot {Re}_{L}^{′} ( i ) - {( {\sum }_{i = 0}^{I} {Re}_{L}^{′} ( i ) )}^{2}} & ( 7 ) \\ β = \frac{{\sum }_{i = 0}^{I} {Re}_{C} ( i ) - α \cdot {\sum }_{i = 0}^{I} {Re}_{L}^{′} ( i )}{I} & ( 8 )\end{matrix}$$

As is understood from the above description, the prediction mode set supported for the intra prediction of HEVC is not the same as the prediction mode set supported for the intra prediction of AVC. If, for example, the luminance component is focused on, while the DC prediction mode and the planar prediction mode are supported in HEVC in some block size, the planar prediction mode is not supported in AVC. If the color difference component is focused on, while the LM mode is supported in HEVC, the LM mode is not supported in AVC. Thus, if a prediction mode selected from the prediction mode set supported in AVC for the base layer is simply reused in an enhancement layer, a better prediction mode in terms of encoding efficiency may be overlooked in the enhancement layer.

(2) Inter Prediction

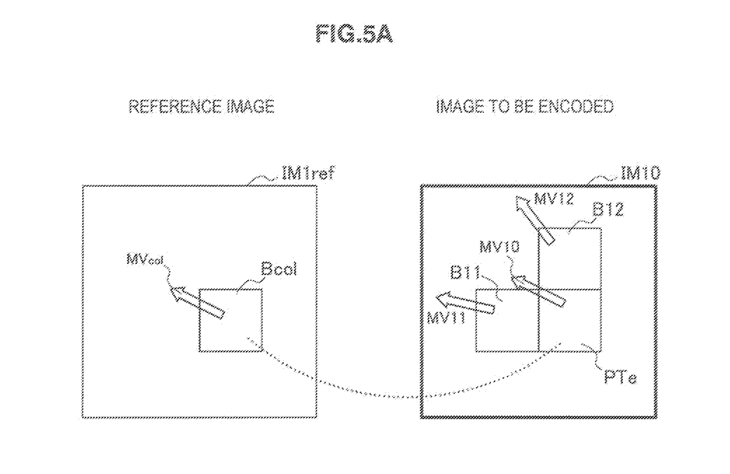

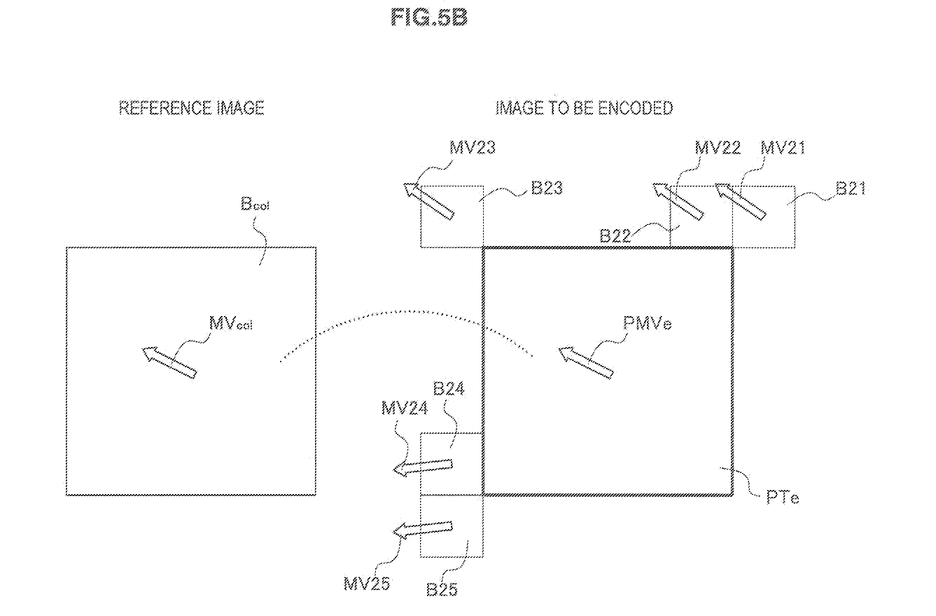

Next, the prediction mode set of the inter prediction in HEVC will be described using FIGS. 5A and 5B.

In HEVC, a merge mode is newly supported as a prediction mode for the inter prediction. The merge mode is a prediction mode that omits encoding of motion information of some prediction block by merging the prediction block with, among reference blocks in the neighborhood in the space direction or the time direction, a block with common motion information. The mode in which a prediction block is merged in the space direction is called a space merge mode and the mode in which a prediction block is merged in the time direction is called a time merge mode.

If, for example, FIG. 5A is referred to, the prediction block PTe in an image IM10 to be encoded is shown. Blocks B11, B12 are neighboring blocks to the left and above the prediction block PTe respectively. A motion vector MV10 is a motion vector calculated for the prediction block PTe. Motion vectors MV11, MV12 are reference motion vectors calculated for neighboring blocks B11, B12 respectively. Further, a colocated block Bcol of the prediction block PTe is shown inside a reference image IM1ref. A motion vector MVcol is a reference motion vector calculated for the colocated block Bcol.

In the example of FIG. 5A, if the motion vector MV10 is equal to the reference motion vector MV11 or MV12, merge information indicating that the prediction block PTe is spatially merged can be encoded. Actually, the merge information can also indicate with which neighboring block the prediction block PTe can merge. If the motion vector MV10 is equal to the reference motion vector MVcol, merge information indicating that the prediction block PTe is temporally merged can be encoded. When the prediction block PTe is spatially or temporally merged, motion vector information and reference image information about the prediction block PTe are not encoded.

When the prediction block PTe is not merged with other blocks, motion vector information about the prediction block PTe is encoded. The mode in which motion vector information is encoded in HEVC is called an AMVP (Advanced Motion Vector Prediction) mode. In AMVP mode, predictor information, differential motion vector information, and reference image information can be encoded as motion information. In contrast to the above prediction formula in AVC, a predictor in AMVP mode does not contain a median operation.

If, for example, FIG. 5B is referred to, the prediction block PTe in the image to be encoded is shown again. Blocks B21 to B25 are neighboring blocks adjacent to the prediction block PTe. The block Bcol is a colocated block of the prediction block PTe in a reference image. When a space predictor is used, predictor information points to one of the blocks B21 to B25. When a time predictor is used, predictor information points to the block Bcol. Then, the motion vector of the reference block pointed to by the predictor information is used as the predicted motion vector PMVe for the prediction block PTe. The differential motion vector MVDe for the prediction block PTe is calculated by the same formula as Formula (2). The AMVP mode in which a space predictor is used is also called a spatial motion vector prediction mode and the AMVP mode in which a time predictor is used is also called a temporal motion vector prediction mode.

As is understood from the above description, the prediction mode set supported for the inter prediction of HEVC is not the same as the prediction mode set supported for the inter prediction of AVC. For example, the direct mode supported by AVC is not supported by HEVC. Also, the merge mode supported by HEVC is not supported by AVC. A predictor used to predict a motion vector in AMVP mode in HEVC is different from a predictor used in AVC. Thus, it is difficult to simply reuse a prediction mode selected from the prediction mode set supported in AVC for the base layer in an enhancement layer.

Also in HEVC, one of the L0 prediction, L1 prediction, and bidirectional prediction can be specified for each block as a reference direction for motion compensation. No reference direction is specified in a block to which the intra prediction mode is applied.

[1-4. Mapping of Prediction Mode]

If the prediction mode of the intra prediction or inter prediction is not shared between layers when a plurality of layers is encoded by different image encoding methods in scalable video coding, the encoding efficiency may be degraded due to an increase of the code amount of prediction mode information. In addition, more processing costs are needed for estimating the prediction mode for encoding. Thus, the technology according to the present disclosure enables the selection of the prediction mode in an enhancement layer based on the prediction mode selected for the base layer by defining mapping of prediction modes between image encoding methods with different prediction mode sets.

Mapping of prediction modes may be defined according to, for example, three criteria described below. It is assumed here that the base layer is encoded by a first encoding method having a first prediction mode set and an enhancement layer is encoded by a second encoding method having a second prediction mode set. It is also assumed that a first block is a prediction block in the base layer and a second block is a prediction block corresponding to the first block in the enhancement layer.

First, as the first criterion, prediction modes in the second prediction mode set corresponding to prediction modes in the first prediction mode set that are not selected for the first block are excluded from the selection of the second block. As the second criterion, prediction modes to be candidates (hereinafter, called candidate modes) for the selection of the second block may contain the prediction mode corresponding to the prediction mode selected for the first block and prediction modes having no corresponding prediction mode in the first prediction mode set. As the third criterion, particularly relating to the inter prediction, when a prediction mode based on spatial correlations of image is selected for the first block, a prediction mode based on spatial correlations of image is selected for the second block. Similarly, when a prediction mode based on temporal correlations of image is selected for the first block, a prediction mode based on temporal correlations of image is selected for the second block. These criteria may be combined in any way. Also, an additional criterion may be introduced or a portion of any criterion may be omitted.

(1) Mapping of Prediction Modes of the Intra Prediction

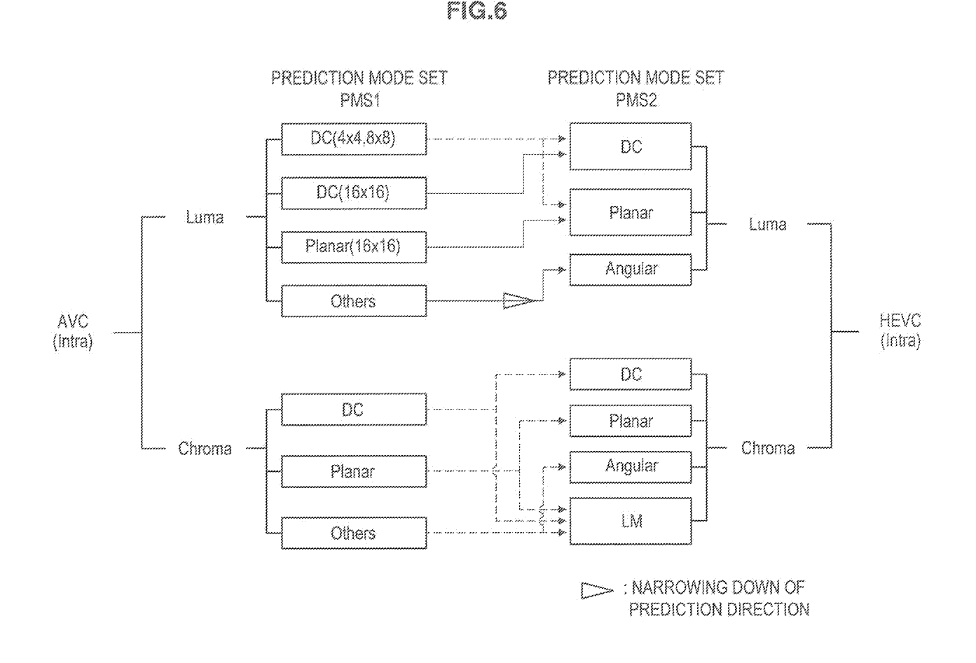

FIG. 6 is an explanatory view illustrating an example of mapping of the prediction mode sets of the intra prediction between AVC and HEVC. Referring to FIG. 6, a prediction mode set PMS1 of AVC is listed on the left side and a prediction mode set PMS2 of HEVC is listed on the right side.

For the prediction block (first block) of 8×8 pixels of the luminance component (Luma) in the base layer, for example, the prediction mode set PMS1 contains the DC prediction mode and eight prediction modes (“Others” in FIG. 6) each associated with specific prediction directions. If the scalability ratio is 1:2, the size of the corresponding prediction block (second block) of the luminance component in the enhancement layer is 16×16 pixels. For the second block, the prediction mode set PMS2 contains the DC prediction mode, the planar prediction mode, and a plurality of angular prediction modes each associated with specific prediction directions. When the DC prediction mode is selected from the prediction mode set PMS1 for the first block, the angular prediction modes are excluded from the selection of the prediction mode for the second block. As a result, an encoder narrows down candidate modes for the second prediction block to two candidate modes of the DC prediction mode and the planar prediction mode and selects the optimum prediction mode from these two candidate modes. In this case, it is enough to encode only 1-bit prediction mode information inside an encoded stream. A decoder decodes the prediction mode information to select the DC prediction mode or the planar prediction mode for the second block.

For the prediction block (first block) of 16×16 pixels of the luminance component (Luma) in the base layer, for example, the prediction mode set PMS1 contains the DC prediction mode, the planar prediction mode, and two prediction modes associated with vertical and horizontal. If the scalability ratio is 1:2, the size of the corresponding prediction block (second block) of the luminance component in the enhancement layer is 32×32 pixels. For the second block, the prediction mode set PMS2 contains the DC prediction mode, the planar prediction mode, and a plurality of angular prediction modes each associated with specific prediction directions. When the DC prediction mode is selected from the prediction mode set PMS1 for the first block, the planar prediction mode and the angular prediction modes are excluded from the selection of the prediction mode for the second block. As a result, the encoder narrows down candidate modes for the second prediction block to the DC prediction mode only. In this case, only one candidate mode remains and the encoder selects the DC prediction mode as the only one candidate mode. In this case, prediction mode information may not be encoded. The decoder selects the DC prediction mode for the second block by referring to the prediction mode specified for the first block. When the planar prediction mode is selected from the prediction mode set PMS1 for the first block, the planar prediction mode is similarly selected for the second block.

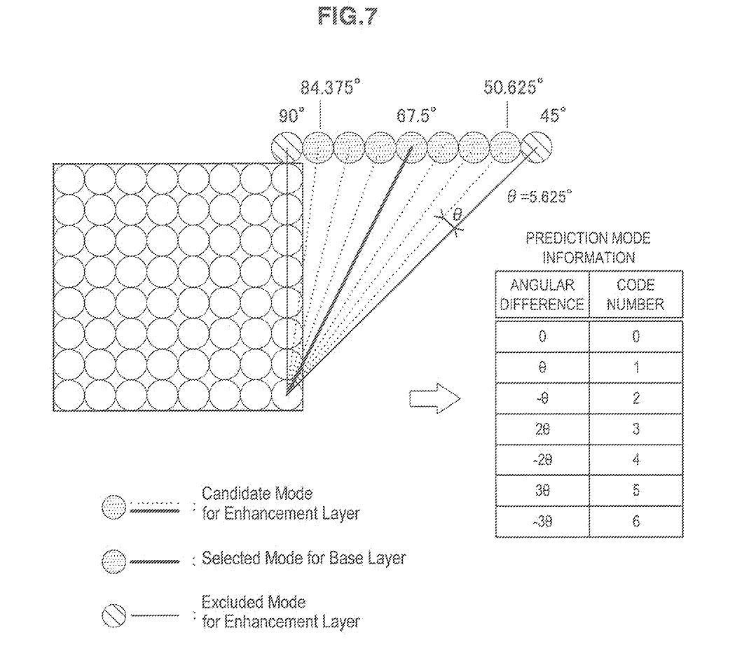

It is assumed that, for example, Mode 7 (vertically left) illustrated in FIG. 2A is selected for the first block as a prediction block of 8×8 pixels of the luminance component in the base layer. In this case, the DC prediction mode and the planar prediction mode are excluded from the selection of the prediction mode for the second block (the planar prediction mode may not be excluded). Further, in the example of FIG. 6, the prediction direction is narrowed down. If, for example, the horizontal direction is 0 degree and the angle increases counterclockwise, the prediction direction of the selected Mode 7 is 67.5 degrees. The prediction direction of Mode 0 is 90 degrees and the prediction direction of Mode 4 is 45 degrees, both of which are not selected. Thus, in the selection of the prediction mode for the second block, the range of the prediction direction of the angular prediction mode can be narrowed down to a range larger than 45 degrees and smaller than 90 degrees. As a result, the encoder narrows down candidate modes for the second block to angular prediction modes corresponding to seven prediction directions in the range of 50.625 degrees to 84.375 degrees and selects the optimum prediction mode from these candidate modes (see FIG. 7). In this case, encoded prediction mode information may be a parameter showing a difference of prediction directions between the prediction mode selected for the first block and the prediction mode selected for the second block. In the example of FIG. 7, using the angular difference 0=5.625 degrees, seven code numbers corresponding to −3θ, −2θ, −θ, 0, θ, 2θ, 3θ are given for prediction mode information. Because the probability that an angular difference between layers in the optimum prediction direction is close to zero is high, the code amount of the enhancement layer after variable encoding can effectively be reduced by attaching a smaller code number to a smaller angular difference. Incidentally, the angular difference θ may be another value (for example, 11.25 degrees) depending on the block size.

For the prediction block (first block) of the color difference component (Chroma) in the base layer, for example, the prediction mode set PMS1 contains the DC prediction mode, the planar prediction mode, and two prediction modes (“Others” in FIG. 6) associated with vertical and horizontal. For the corresponding prediction block (second block) of the color difference component (Chroma) in the enhancement layer, the prediction mode set PMS2 contains the DC prediction mode, the planar prediction mode, two prediction modes associated with vertical and horizontal, and the LM mode. When the DC prediction mode is selected from the prediction mode set PMS1 for the first block, the planar prediction mode and the angular prediction modes are excluded from the selection of the prediction mode for the second block. As a result, the encoder narrows down candidate modes for the second prediction block to two candidate modes of the DC prediction mode and the LM mode and selects the optimum prediction mode from these two candidate modes. In this case, it is enough to encode only 1-bit prediction mode information inside an encoded stream. The decoder decodes the prediction mode information to select the DC prediction mode or the LM mode for the second block. When a prediction mode other than the DC prediction mode is selected from the prediction mode set PMS1 for the first block, candidate modes are narrowed down to two modes of the prediction mode selected for the first block and the LM mode.

(2) Mapping of Prediction Modes of the Inter Prediction

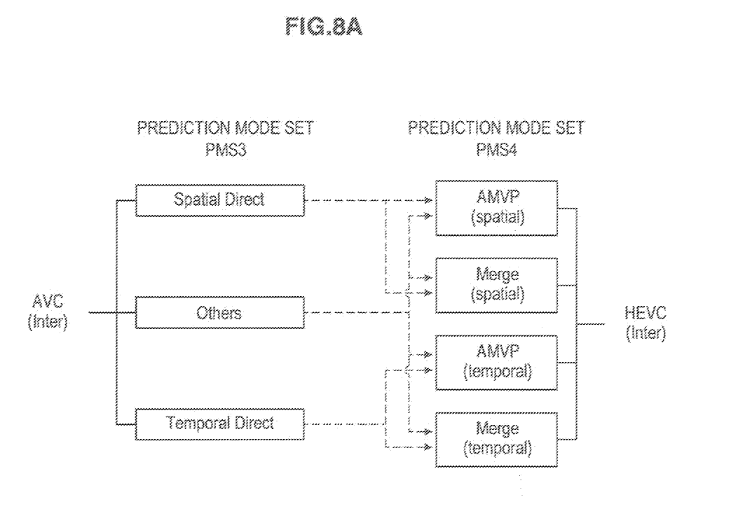

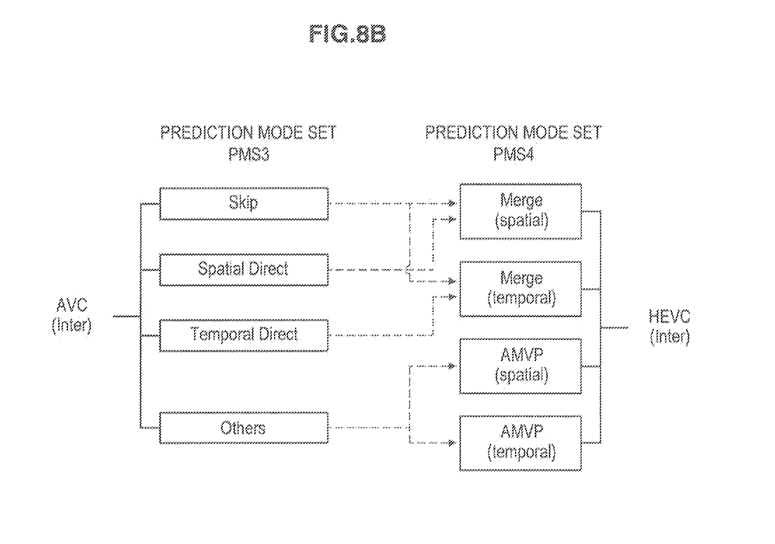

FIG. 8A is an explanatory view illustrating a first example of mapping of the prediction mode sets of the inter prediction between AVC and HEVC. Referring to FIG. 8A, a prediction mode set PMS3 of AVC is listed on the left side and a prediction mode set PMS4 of HEVC is listed on the right side.

For the prediction block (first block) in the base layer, for example, the prediction mode set PMS3 contains the space direct mode, the time direct mode, and other prediction modes. For the corresponding prediction block (second block) in the enhancement layer, the prediction mode set PMS4 contains the spatial motion vector prediction mode (spatial AMVP mode), the space merge mode, the temporal motion vector prediction mode (temporal AMVP mode), and the time merge mode. When the space direct mode (based on spatial correlations of image) is selected from the prediction mode set PMS3 for the first block, candidate modes for the second block are narrowed down to two modes of the spatial motion vector prediction mode and the space merge mode (similarly based on spatial correlations). The encoder selects the optimum prediction mode from these two candidate modes. Similarly, when the time direct mode (based on temporal correlations of image) is selected from the prediction mode set PMS3 for the first block, candidate modes for the second block are narrowed down to two modes of the temporal motion vector prediction mode and the time merge mode (similarly based on temporal correlations). The encoder selects the optimum prediction mode from these two candidate modes. When a non-direct mode is selected from the prediction mode set PMS3, candidate modes for the second block may not be narrowed down. By adopting such mapping, the code amount of prediction mode information to be encoded can be reduced and also the processing cost for estimating the prediction mode for encoding can be reduced. Because prediction modes are mapped according to similarities of correlation characteristics of image, the code amount can be reduced without degrading prediction precision of the inter prediction in the enhancement layer.

FIG. 8B is an explanatory view illustrating a second example of mapping of the prediction mode sets of the inter prediction between AVC and HEVC. In the second example, a fourth criterion that is different from the above criteria is introduced for mapping of prediction modes. As the fourth criterion, when the omission of encoding of motion vector information is selected for the first block, a prediction mode that omits encoding of motion vector information is similarly selected for the second block. Referring to FIG. 8B, the prediction mode set PMS3 of AVC is listed on the left side again and the prediction mode set PMS4 of HEVC on the right side. In FIG. 8B, however, that the prediction mode set PMS3 contains the skip mode is clearly shown.

When, for example, the space or time direct mode or the skip mode is specified for the first block, candidate modes for the second block are narrowed down to the merge mode. When the space direct mode is specified for the first block, the prediction mode for the second block may be the space merge mode. Similarly, when the time direct mode is specified for the first block, the prediction mode for the second block may be the time merge mode. When the skip mode is specified for the first block, the encoder can select the space merge mode or the time merge mode as the optimum prediction mode for the second block. On the other hand, when a prediction mode other than the direct mode and the skip mode is specified for the first block, candidate modes for the second block are narrowed down to the motion vector prediction mode. In this case, the encoder can select the spatial motion vector prediction mode or the temporal motion vector prediction mode as the optimum prediction mode for the second block. Also by adopting such mapping, the code amount of prediction mode information to be encoded can be reduced and also the processing cost for estimating the prediction mode for encoding can be reduced. Because prediction modes are mapped according to similarities of correlation characteristics of image, the code amount can be reduced without degrading prediction precision of the inter prediction in the enhancement layer.

In both of two examples described here, the reference direction selected for the first block in the base layer may be reused for the second block in the enhancement layer. That is, when the L0 prediction is selected for the first block, the L0 prediction can be selected for the corresponding second block. When the L1 prediction is selected for the first block, the L1 prediction can be selected for the corresponding second block. When the bidirectional prediction is selected for the first block, the bidirectional prediction can be selected for the corresponding second block. Accordingly, the code amount to encode the reference direction in the enhancement layer can be reduced.

Incidentally, mapping of prediction modes shown in this section is only an example. Mapping of different forms can also be used.

[1-5. Basic Configuration Example of Encoder]

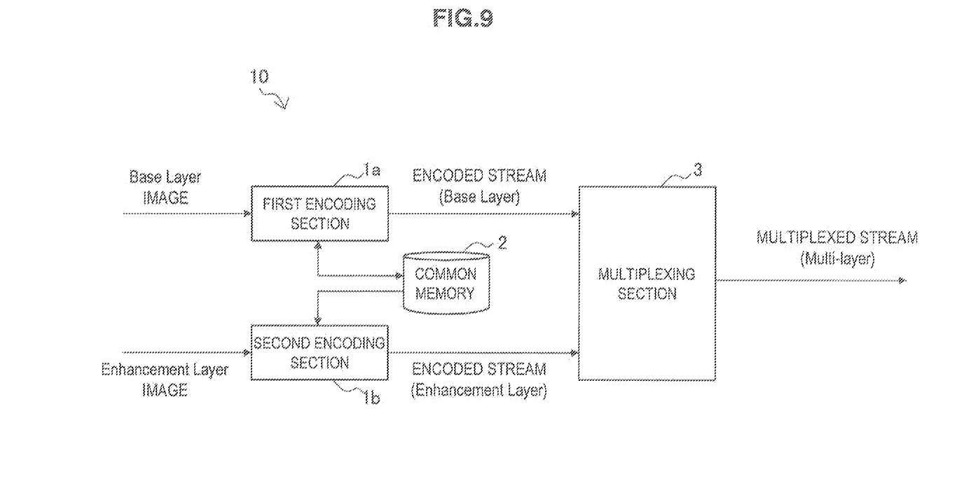

FIG. 9 is a block diagram showing a schematic configuration of an image encoding device 10 according to an embodiment supporting scalable video coding. Referring to FIG. 9, the image encoding device 10 includes a first encoding section 1a, a second encoding section 1b, a common memory 2, and a multiplexing section 3.

The first encoding section 1a encodes a base layer image to generate an encoded stream of the base layer. The second encoding section 1b encodes an enhancement layer image to generate an encoded stream of an enhancement layer. The common memory 2 stores information commonly used between layers. The multiplexing section 3 multiplexes an encoded stream of the base layer generated by the first encoding section 1a and an encoded stream of at least one enhancement layer generated by the second encoding section 1b to generate a multilayer multiplexed stream.

[1-6. Basic Configuration Example of Decoder]

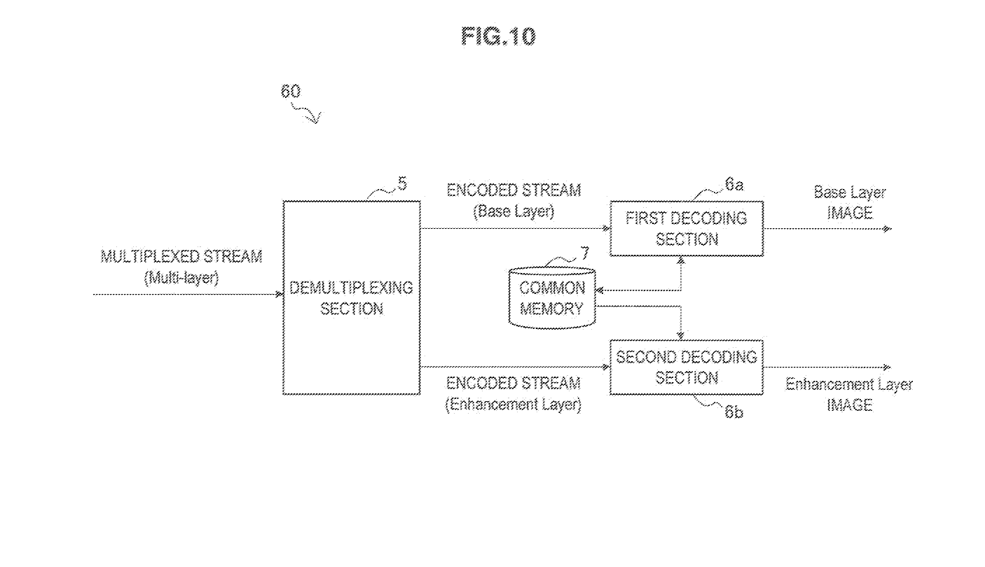

FIG. 10 is a block diagram showing a schematic configuration of an image decoding device 60 according to an embodiment supporting scalable video coding. Referring to FIG. 10, the image decoding device 60 includes a demultiplexing section 5, a first decoding section 6a, a second decoding section 6b, and a common memory 7.

The demultiplexing section 5 demultiplexes a multilayer multiplexed stream into an encoded stream of the base layer and an encoded stream of at least one enhancement layer. The first decoding section 6a decodes a base layer image from an encoded stream of the base layer. The second decoding section 6b decodes an enhancement layer image from an encoded stream of an enhancement layer. The common memory 7 stores information commonly used between layers.

In the image encoding device 10 illustrated in FIG. 9, the configuration of the first encoding section 1a to encode the base layer and that of the second encoding section 1b to encode an enhancement layer are similar to each other. Some parameters generated or acquired by the first encoding section 1a are buffered by using the common memory 2 and reused by the second encoding section 1b. In the next section, such a configuration of the first encoding section 1a and the second encoding section 1b will be described in detail.

Similarly, in the image decoding device 60 illustrated in FIG. 10, the configuration of the first decoding section 6a to decode the base layer and that of the second decoding section 6b to decode an enhancement layer are similar to each other. Some parameters generated or acquired by the first decoding section 6a are buffered by using the common memory 7 and reused by the second decoding section 6b. Further in the next section, such a configuration of the first decoding section 6a and the second decoding section 6b will be described in detail.

### 2. Configuration Example of Encoding Section According to an Embodiment

[2-1. Overall Configuration]

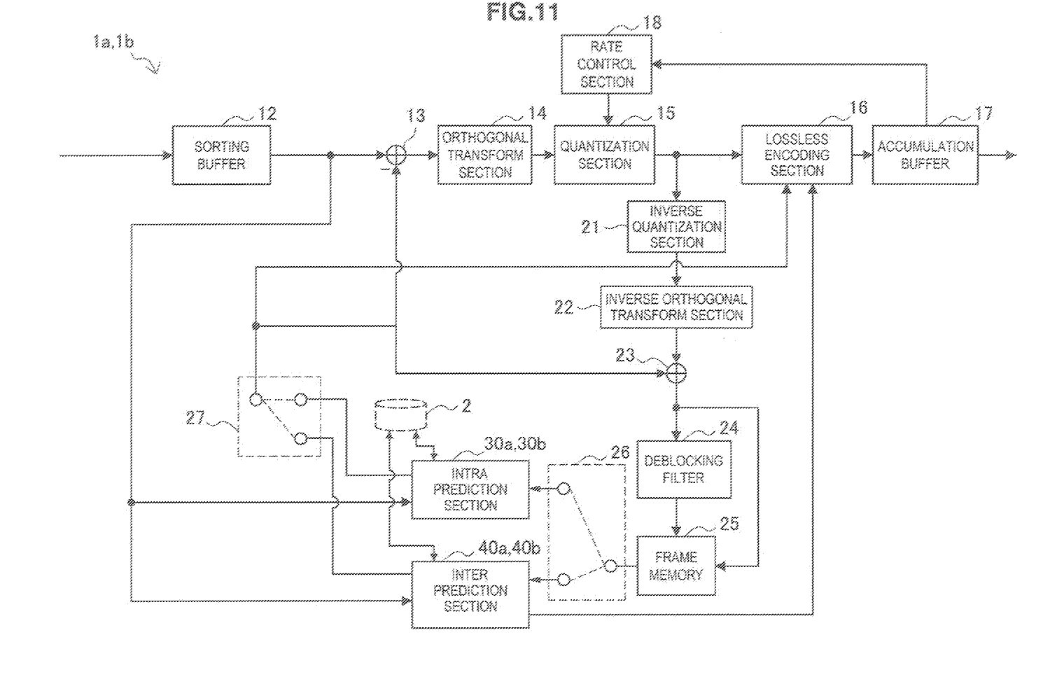

FIG. 11 is a block diagram showing an example of the configuration of the first encoding section 1a and the second encoding section 1b shown in FIG. 9. Referring to FIG. 11, the first encoding section 1a includes a sorting buffer 12, a subtraction section 13, an orthogonal transform section 14, a quantization section 15, a lossless encoding section 16, an accumulation buffer 17, a rate control section 18, an inverse quantization section 21, an inverse orthogonal transform section 22, an addition section 23, a deblocking filter 24, a frame memory 25, selectors 26, 27, an intra prediction section 30a, and an inter prediction section 40a. The second encoding section 1b includes an intra prediction section 30b instead of the intra prediction section 30a, and an inter prediction section 40b instead of the inter prediction section 40a.

The sorting buffer 12 sorts the images included in the series of image data. After sorting the images according to a GOP (Group of Pictures) structure according to the encoding process, the sorting buffer 12 outputs the image data which has been sorted to the subtraction section 13, the intra prediction section 30a or 30b and the inter prediction section 40a or 40b.

The image data input from the sorting buffer 12 and predicted image data input by the intra prediction section 30a or 30b or the inter prediction section 40a or 40b described later are supplied to the subtraction section 13. The subtraction section 13 calculates predicted error data which is a difference between the image data input from the sorting buffer 12 and the predicted image data and outputs the calculated predicted error data to the orthogonal transform section 14.

The orthogonal transform section 14 performs orthogonal transform on the predicted error data input from the subtraction section 13. The orthogonal transform to be performed by the orthogonal transform section 14 may be discrete cosine transform (DCT) or Karhunen-Loeve transform, for example. The orthogonal transform section 14 outputs transform coefficient data acquired by the orthogonal transform process to the quantization section 15.

The transform coefficient data input from the orthogonal transform section 14 and a rate control signal from the rate control section 18 described later are supplied to the quantization section 15. The quantization section 15 quantizes the transform coefficient data, and outputs the transform coefficient data which has been quantized (hereinafter, referred to as quantized data) to the lossless encoding section 16 and the inverse quantization section 21. Also, the quantization section 15 switches a quantization parameter (a quantization scale) based on the rate control signal from the rate control section 18 to thereby change the bit rate of the quantized data.

The lossless encoding section 16 generates an encoded stream of each layer by performing a lossless encoding process on quantized data of each layer input from the quantization section 15. The lossless encoding section 16 also encodes information about an intra prediction or information about an inter prediction input from the selector 27 and multiplexes encoded parameters into the header region of an encoded stream. Then, the lossless encoding section 16 outputs the generated encoded stream to the accumulation buffer 17.

The accumulation buffer 17 temporarily accumulates an encoded stream input from the lossless encoding section 16 using a storage medium such as a semiconductor memory. Then, the accumulation buffer 17 outputs the accumulated encoded stream to a transmission section (not shown) (for example, a communication interface or an interface to peripheral devices) at a rate in accordance with the band of a transmission path.

The rate control section 18 monitors the free space of the accumulation buffer 17. Then, the rate control section 18 generates a rate control signal according to the free space on the accumulation buffer 17, and outputs the generated rate control signal to the quantization section 15. For example, when there is not much free space on the accumulation buffer 17, the rate control section 18 generates a rate control signal for lowering the bit rate of the quantized data. Also, for example, when the free space on the accumulation buffer 17 is sufficiently large, the rate control section 18 generates a rate control signal for increasing the bit rate of the quantized data.

The inverse quantization section 21 performs an inverse quantization process on the quantized data input from the quantization section 15. Then, the inverse quantization section 21 outputs transform coefficient data acquired by the inverse quantization process to the inverse orthogonal transform section 22.

The inverse orthogonal transform section 22 performs an inverse orthogonal transform process on the transform coefficient data input from the inverse quantization section 21 to thereby restore the predicted error data. Then, the inverse orthogonal transform section 22 outputs the restored predicted error data to the addition section 23.

The addition section 23 adds the restored predicted error data input from the inverse orthogonal transform section 22 and the predicted image data input from the intra prediction section 30a or 30b or the inter prediction section 40a or 40b to thereby generate decoded image data (so-called reconstructed image). Then, the addition section 23 outputs the generated decoded image data to the deblocking filter 24 and the frame memory 25.

The deblocking filter 24 performs a filtering process for reducing block distortion occurring at the time of encoding of an image. The deblocking filter 24 filters the decoded image data input from the addition section 23 to remove the block distortion, and outputs the decoded image data after filtering to the frame memory 25.

The frame memory 25 stores, using a storage medium, the decoded image data input from the addition section 23 and the decoded image data after filtering input from the deblocking filter 24.

The selector 26 reads the decoded image data before filtering which is to be used for intra prediction from the frame memory 25, and supplies the decoded image data which has been read to the intra prediction section 30a or 30b as reference image data. Further, the selector 26 reads filtered decoded image data to be used for inter prediction from the frame memory 25, and supplies the inter prediction section 40a or 40b with the read decoded image data as reference image data.

In the intra prediction mode, the selector 27 outputs predicted image data as a result of intra prediction output from the intra prediction section 30a or 30b to the subtraction section 13 and also outputs information about the intra prediction to the lossless encoding section 16. Further, in the inter prediction mode, the selector 27 outputs predicted image data as a result of inter prediction output from the inter prediction section 40a or 40b to the subtraction section 13 and also outputs information about the inter prediction to the lossless encoding section 16. The selector 27 switches the inter prediction mode and the intra prediction mode in accordance with the magnitude of a cost function value.

The intra prediction section 30a performs an intra prediction process for each prediction block of AVC based on original image data and decoded image data of the base layer. For example, the intra prediction section 30a evaluates prediction results in each prediction mode using a predetermined cost function. Next, the intra prediction section 30a selects the prediction mode in which the cost function value is minimum, that is, the compression rate is the highest as the optimum prediction mode. Also, the intra prediction section 30a generates predicted image data of the base layer according to the optimum prediction mode. Then, the intra prediction section 30a outputs information about the intra prediction including prediction mode information indicating the selected optimum prediction mode, the cost function value, and predicted image data to the selector 27. Also, the intra prediction section 30a causes the common memory 2 to buffer prediction mode information.

The intra prediction section 30b performs the intra prediction process for each prediction unit of HEVC based on original image data and decoded image data of an enhancement layer. For example, the intra prediction section 30b evaluates prediction results in each prediction mode using a predetermined cost function. Next, the intra prediction section 30b selects the prediction mode in which the cost function value is minimum, that is, the compression rate is the highest as the optimum prediction mode. Also, the intra prediction section 30b generates predicted image data of an enhancement layer according to the optimum prediction mode. Then, the intra prediction section 30b outputs information about the intra prediction including prediction mode information indicating the selected optimum prediction mode, the cost function value, and predicted image data to the selector 27. The intra prediction section 30b also acquires prediction mode information of the base layer buffered by the common memory 2. The prediction mode information of the base layer represents one of prediction modes in the prediction mode set supported by AVC for each prediction block. Based on such prediction mode information, the intra prediction section 30b narrows down candidate modes (prediction modes in the prediction mode set supported by HEVC) estimated for the intra prediction process of the enhancement layer.

The inter prediction section 40a performs a motion estimation process for each prediction block of AVC based on original image data and decoded image data of the base layer. For example, the inter prediction section 40a evaluates prediction results in each prediction mode using a predetermined cost function. Next, the inter prediction section 40a selects the prediction mode in which the cost function value is minimum, that is, the compression rate is the highest as the optimum prediction mode. Also, the inter prediction section 40a generates predicted image data of the base layer according to the optimum prediction mode. Then, the inter prediction section 40a outputs information about the inter prediction including prediction mode information indicating the selected optimum prediction mode and reference image information, the cost function value, and predicted image data to the selector 27. Also, the inter prediction section 40a causes the common memory 2 to buffer the prediction mode information and the reference image information.

The inter prediction section 40b performs the motion estimation process for each prediction unit of HEVC based on original image data and decoded image data of an enhancement layer. For example, the inter prediction section 40b evaluates prediction results in each prediction mode using a predetermined cost function. Next, the inter prediction section 40b selects the prediction mode in which the cost function value is minimum, that is, the compression rate is the highest as the optimum prediction mode. Also, the inter prediction section 40b generates predicted image data of an enhancement layer according to the optimum prediction mode. Then, the inter prediction section 40b outputs information about the inter prediction including prediction mode information indicating the selected optimum prediction mode and reference image information, the cost function value, and predicted image data to the selector 27. Also, the inter prediction section 40b acquires prediction mode information of the base layer buffered by the common memory 2. The prediction mode information of the base layer represents one of prediction modes in the prediction mode set supported by AVC for each prediction block. Based on such prediction mode information, the inter prediction section 40b narrows down candidate modes (prediction modes in the prediction mode set supported by HEVC) estimated for the motion estimation process of the enhancement layer. The reference image information may be reused between layers.

The first encoding section 1a performs a series of encoding processes described here on a sequence of image data of the base layer. The second encoding section 1b performs a series of encoding processes described here on a sequence of image data of an enhancement layer. When a plurality of enhancement layers is present, the encoding process of the enhancement layer can be repeated as many times as the number of enhancement layers. The encoding process of the base layer and that of an enhancement layer may be performed by being synchronized in the processing unit, for example, the encoding unit or the prediction unit.

[2-2. Detailed Configuration of Intra Prediction Section]

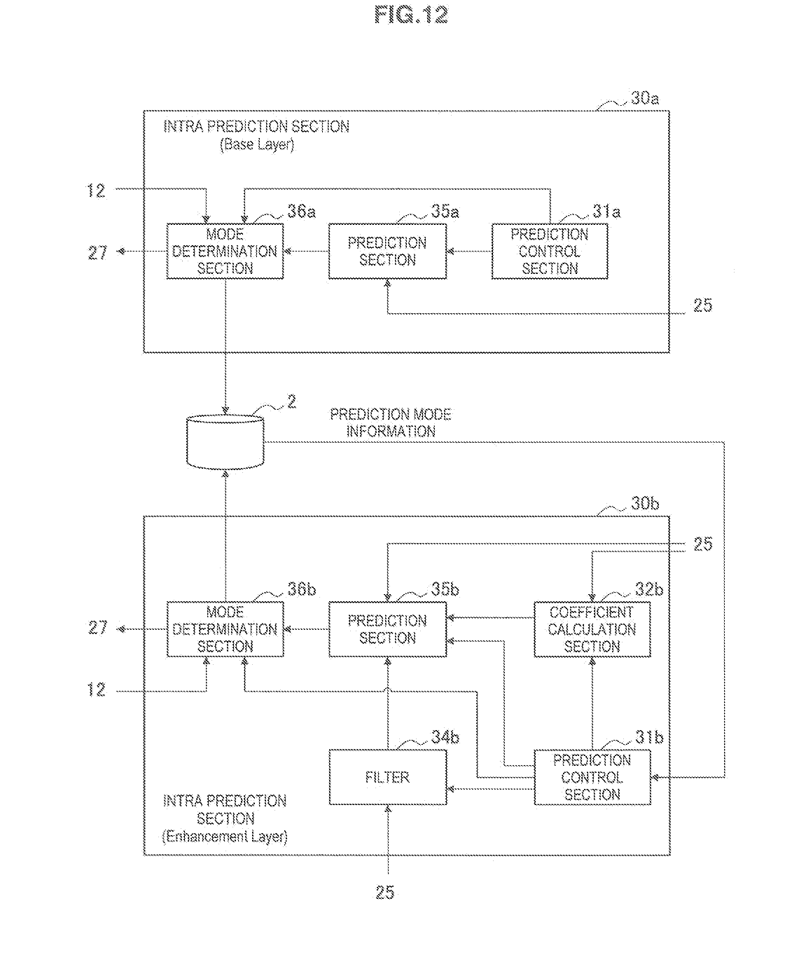

FIG. 12 is a block diagram showing an example of a detailed configuration of the intra prediction sections 30a, 30b shown in FIG. 11. Referring to FIG. 12, the intra prediction section 30a includes a prediction control section 31a, a prediction section 35a, and a mode determination section 36a. The intra prediction section 30b includes a prediction control section 31b, a coefficient calculation section 32b, a filter 34b, a prediction section 35b, and a mode determination section 36b.

(1) Intra Prediction Process of the Base Layer

The prediction control section 31a of the intra prediction section 30a controls the intra prediction process of the base layer according to specifications of AVC. For example, the prediction control section 31a performs the intra prediction process of each color component for each prediction block.

More specifically, the prediction control section 31a causes the prediction section 35a to generate a predicted image of each prediction block in a plurality of prediction modes in the prediction mode set PMS1 illustrated in FIG. 6 and causes the mode determination section 36a to determine the optimum prediction mode. The prediction section 35a generates a predicted image of each prediction block according to various candidate modes for each color component under the control of the prediction control section 31a. The mode determination section 36a calculates the cost function value for each prediction mode based on original image data and predicted image data input from the prediction section 35a. The mode determination section 36a selects the optimum prediction mode for each color component based on the calculated cost function value. Then, the mode determination section 36a outputs information about the intra prediction including prediction mode information indicating the selected optimum prediction mode, the cost function value, and predicted image data of each color component to the selector 27.

The mode determination section 36a also stores prediction mode information indicating the optimum prediction mode for each prediction block in the base layer in a mode information buffer provided in the common memory 2.

(2) Intra Prediction Process for an Enhancement Layer

The prediction control section 31b of the intra prediction section 30b controls the intra prediction process of an enhancement layer according to specifications of HEVC. For example, the prediction control section 31b performs the intra prediction process of each color component for each prediction block.

More specifically, the prediction control section 31b causes the prediction section 35b to generate a predicted image of each prediction unit in one or more prediction modes (candidate modes) in the prediction mode set PMS2 illustrated in FIG. 6. Candidate modes are narrowed down based on prediction mode information of the base layer (or a lower layer) acquired from the mode information buffer. When a plurality of candidate modes is present, the prediction control section 31b causes the mode determination section 36b to determine the optimum prediction mode.

The coefficient calculation section 32b calculates coefficient of a prediction function used by the prediction section 35b in LM mode according to Formula (7) and Formula (8) described above. The filter 34b generates an input value into the prediction function in LM mode by down-sampling pixel values of the luminance component in accordance with the chroma format.

The prediction section 35b generates a predicted image of each prediction unit according to the candidate mode specified by the prediction control section 31b.

It is assumed that, for example, the block size of the prediction unit to be predicted (hereinafter, called an attention PU) of the luminance component is 16×16 pixels and the block size of the corresponding prediction block (hereinafter, called a corresponding block) in the base layer is 8×8 pixels. When the prediction mode information of the base layer indicates that the DC prediction mode is selected for the corresponding block, candidate modes are narrowed down to the DC prediction mode and the planar prediction mode. In this case, the prediction section 35b generates a predicted image in DC prediction mode and a predicted image in planar prediction mode.

It is also assumed that, for example, the block size of the attention PU of the luminance component is 32×32 pixels and the block size of the corresponding prediction block is 16×16 pixels. When the prediction mode information of the base layer indicates that the DC prediction mode is selected for the corresponding block, candidate modes are narrowed down to the DC prediction mode only. When the prediction mode information of the base layer indicates that the planar prediction mode is selected for the corresponding block in the same case, candidate modes are narrowed down to the planar prediction mode only.

When, for example, the prediction mode information of the base layer indicates that a prediction mode associated with a specific prediction mode is selected for the corresponding block corresponding to the attention PU of the luminance component, candidate modes are narrowed down to the angular prediction modes. Further, the prediction direction in angular prediction mode can be narrowed down to a range close to the prediction direction of the prediction mode of the base layer.

Also, for the attention PU of the color difference component, for example, candidate modes are narrowed down to the prediction mode selected for the corresponding block and the LM mode.

The mode determination section 36b calculates the cost function value of each prediction mode based on original image data and predicted image data input from the prediction section 35b. Then, the mode determination section 36b selects the prediction mode of each color component for each prediction unit. When a plurality of candidate modes is present, the prediction mode showing the minimum cost function value is selected and prediction mode information indicating the prediction mode selected from among narrowed-down candidate modes is generated. When only one candidate mode is present, prediction mode information may not be generated. Then, the mode determination section 36b outputs information about the intra prediction that can include prediction mode information, cost function values, and predicted image data of each color component to the selector 27.

When a higher layer is present, the mode determination section 36b may store prediction mode information for each prediction unit in the mode information buffer.

[2-3. Detailed Configuration of Inter Prediction Section]

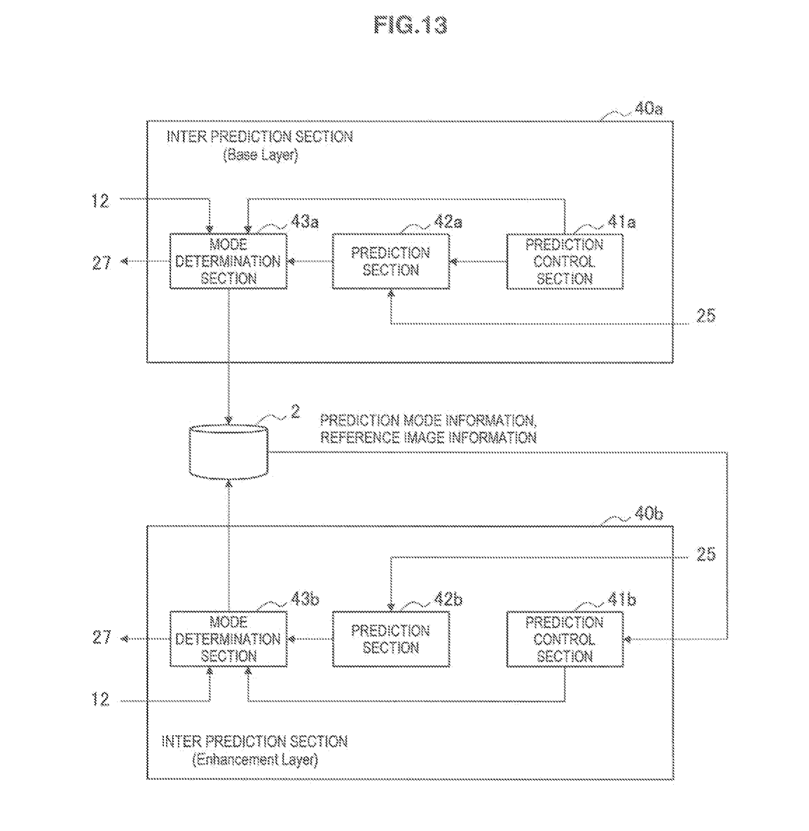

FIG. 13 is a block diagram showing an example of a detailed configuration of the inter prediction sections 40a, 40b shown in FIG. 11. Referring to FIG. 13, the inter prediction section 40a includes a prediction control section 41a, a prediction section 42a, and a mode determination section 43a. The inter prediction section 40b includes a prediction control section 41b, a prediction section 42b, and a mode determination section 43b.

(1) Motion Estimation Process of the Base Layer

The prediction control section 41a of the inter prediction section 40a controls the motion estimation process of the base layer according to specifications of AVC. For example, the prediction control section 41a performs the motion estimation process of each color component for each prediction block.

More specifically, the prediction control section 41a causes the prediction section 42a to generate a predicted image of each prediction block in a plurality of prediction modes in the prediction mode set PMS3 illustrated in FIG. 8A or 8B and causes the mode determination section 43a to determine the optimum prediction mode. The prediction section 42a generates a predicted image of each prediction block according to various candidate modes for each color component under the control of the prediction control section 41a. The mode determination section 43a calculates the cost function value for each prediction mode based on original image data and predicted image data input from the prediction section 42a. The mode determination section 43a selects the optimum prediction mode for each color component based on the calculated cost function value. Then, the mode determination section 43a outputs information about the inter prediction including prediction mode information indicating the selected optimum prediction mode and reference image information, the cost function value, and predicted image data of each color component to the selector 27.

The mode determination section 43a stores prediction mode information for each prediction block in the base layer and reference image information in the motion information buffer provided in the common memory 2.

(2) Motion Estimation Process of an Enhancement Layer

The prediction control section 41b of the inter prediction section 40b controls the motion estimation process of an enhancement layer according to specifications of HEVC. For example, the prediction control section 41b performs the motion estimation process of each color component for each prediction unit.

More specifically, the prediction control section 41b causes the prediction section 42b to generate a predicted image of each prediction unit in one or more prediction modes (candidate modes) in the prediction mode set PMS4 illustrated in FIG. 8A or 8B. Candidate modes are narrowed down based on prediction mode information of the base layer (or a lower layer) acquired from the motion information buffer. When a plurality of candidate modes is present, the prediction control section 41b causes the mode determination section 43b to determine the optimum prediction mode.

The prediction section 42b generates a predicted image of each prediction unit according to the candidate mode specified by the prediction control section 41b. A reference image can be determined according to reference image information acquired from the motion information buffer.

When, for example, the prediction mode information of the base layer indicates that the space direct mode is selected for the corresponding block in the base layer, candidate modes for the attention PU are narrowed down to the space merge mode and the spatial motion vector prediction mode. In this case, the prediction section 42b generates a predicted image in space merge mode and a predicted image in spatial motion vector prediction mode. Instead, when the prediction mode information of the base layer indicates that the space direct mode is selected for the corresponding block in the base layer, the space merge mode may be determined as the prediction mode of the attention PU.

When, for example, the prediction mode information of the base layer indicates that the time direct mode is selected for the corresponding block in the base layer, candidate modes for the attention PU are narrowed down to the time merge mode and the time motion vector prediction mode. In this case, the prediction section 42b generates a predicted image in time merge mode and a predicted image in time motion vector prediction mode. Instead, when the prediction mode information of the base layer indicates that the time direct mode is selected for the corresponding block in the base layer, the time merge mode may be determined as the prediction mode of the attention PU.

When, for example, the prediction mode information of the base layer indicates that the skip mode is selected for the corresponding block in the base layer, prediction modes for the attention PU may be narrowed down to the merge modes. In this case, the prediction section 42b generates a predicted image in space merge mode and a predicted image in time merge mode.

When, for example, the prediction mode information of the base layer indicates that a non-direct mode is selected for the corresponding block in the base layer, the prediction section 42b can generate predicted images in all prediction modes supported by HEVC without candidate modes for the attention PU being narrowed down. Like the example shown in FIG. 8B, candidate modes for the attention PU may be narrowed down depending on whether the direct mode or the skip mode is selected for the corresponding block in the base layer (if, for example, these modes are not selected, candidate modes for the attention PU can be narrowed down to the AMVP mode).

Further, for example, the prediction section 42b may reuse the reference direction between layers. In this case, the prediction section 42b can generate a predicted image according to the reference direction (the L0 prediction, L1 prediction, or bidirectional prediction) used for the corresponding block in the base layer.

The mode determination section 43b calculates the cost function value of each prediction mode based on original image data and predicted image data input from the prediction section 42b. Then, the mode determination section 43b selects the prediction mode of each color component for each prediction unit. When a plurality of candidate modes is present, the prediction mode showing the minimum cost function value is selected and prediction mode information indicating the prediction mode selected from among narrowed-down candidate modes is generated. Then, the mode determination section 43b outputs information about the inter prediction that can include prediction mode information, cost function values, and predicted image data of each color component to the selector 27.

When a higher layer is present, the mode determination section 43a may store prediction mode information for each prediction unit in the motion information buffer.

### 3. Process Flow for Encoding According to an Embodiment

(1) Schematic Flow

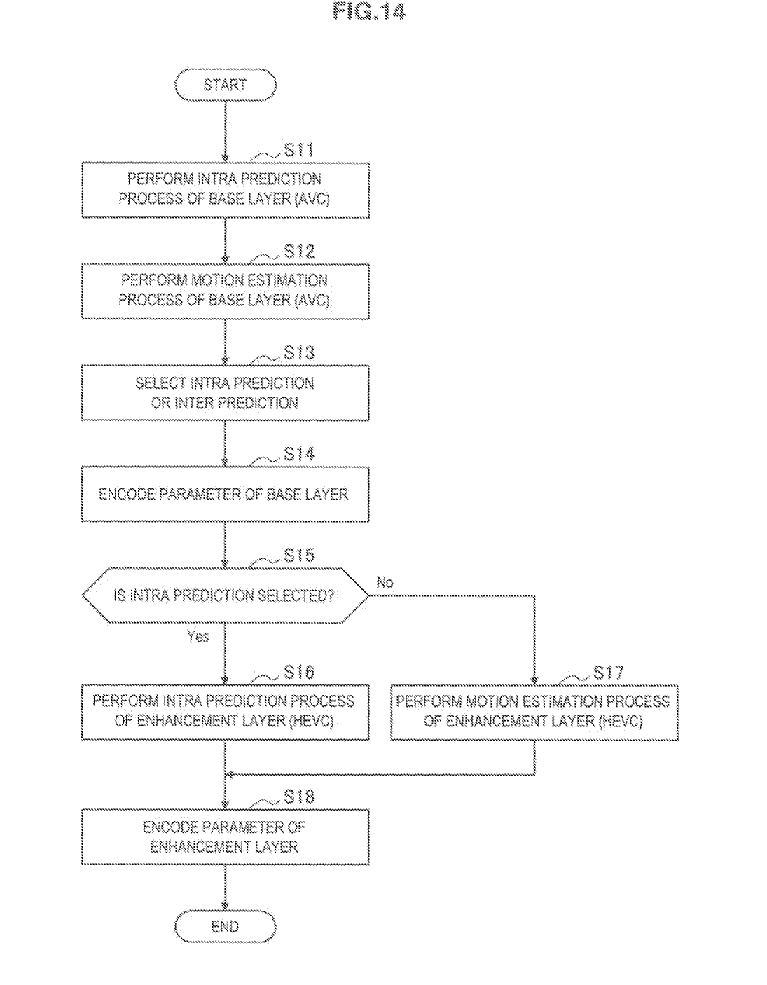

FIG. 14 is a flow chart showing an example of a schematic process flow for encoding according to an embodiment. For the sake of brevity of description, process steps that are not directly related to technology according to the present disclosure are omitted from FIG. 14.

Referring to FIG. 14, the intra prediction section 30a for the base layer first performs an intra prediction process of the base layer according to specifications of AVC (step S11). The intra prediction section 30a stores prediction mode information for each prediction block in the common memory 2.

Next, the inter prediction section 40a for the base layer performs a motion estimation process of the base layer according to specifications of AVC (step S12). The inter prediction section 40a stores prediction mode information for each prediction block and reference image information in the common memory 2.

Next, the selector 27 selects the intra prediction mode or the inter prediction mode by comparing cost function values input from the intra prediction section 30a and the inter prediction section 40a (step S13).

Next, when the intra prediction mode is selected, the lossless encoding section 16 encodes information about the intra prediction input from the intra prediction section 30a. When the inter prediction mode is selected, the lossless encoding section 16 encodes information about the inter prediction input from the inter prediction section 40a (step S14).

Next, when the intra prediction mode is selected for some prediction block of the base layer (step S15), the intra prediction section 30b for an enhancement layer performs the intra prediction process for the corresponding prediction unit in the enhancement layer (step S16). Candidates of the prediction mode are narrowed down based on prediction mode information of the base layer acquired from the common memory 2.

When the inter prediction mode is selected for some prediction block of the base layer (step S15), the inter prediction section 40b for an enhancement layer performs the motion estimation process for the corresponding prediction unit in the enhancement layer (step S17). Candidates of the prediction mode are narrowed down based on prediction mode information of the base layer acquired from the common memory 2. Reference image information can also be reused.

Next, the lossless encoding section 16 encodes information about the intra prediction input from the intra prediction section 30b or information about the inter prediction input from the inter prediction section 40b (step S18).

(2) Intra Prediction Process for an Enhancement Layer

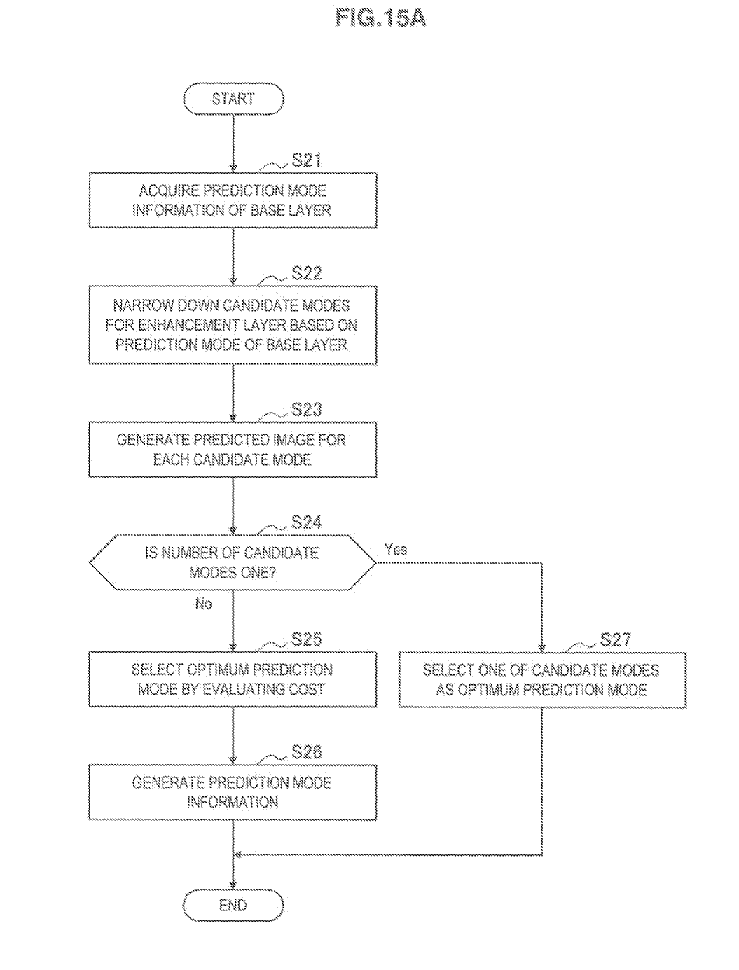

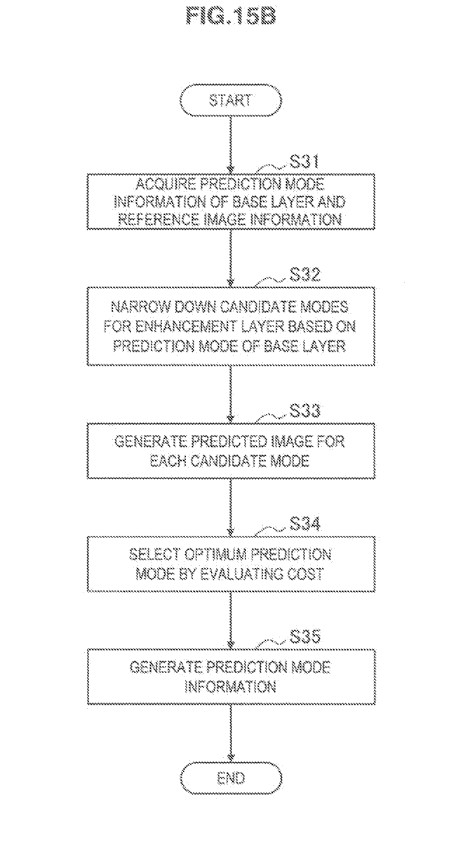

FIG. 15A is a flow chart showing an example of a detailed flow of the intra prediction process for the enhancement layer during encoding corresponding to step S16 in FIG. 14.

Referring to FIG. 15A, the intra prediction section 30b first acquires prediction mode information of the base layer buffered by the common memory 2 (step S21).

Next, the intra prediction section 30b narrows down candidate modes of the intra prediction for the enhancement layer based on the prediction mode of the base layer indicated by the acquired prediction mode information (step S22).

Next, the intra prediction section 30b generates a predicted image according to each of candidate modes narrowed down based on the prediction mode of the base layer in step S22 (step S23).

Next, when a plurality of candidate modes is present (step S24), the intra prediction section 30b selects the optimum prediction mode by evaluating the cost calculated based on original image data and predicted image data (step S25). The intra prediction section 30b also generates prediction mode information indicating the prediction mode selected from among narrowed-down candidate modes (step S26).

On the other hand, when only one candidate mode is present (step S24), the intra prediction section 30b selects the one candidate mode as the optimum prediction mode (step S27). In this case, prediction mode information is not generated.

(3) Motion Estimation Process for an Enhancement Layer

FIG. 15B is a flow chart showing an example of the detailed flow of the motion estimation process for the enhancement layer during encoding corresponding to step S17 in FIG. 14.

Referring to FIG. 15B, the inter prediction section 40b first acquires prediction mode information of the base layer and reference image information buffered by the common memory 2 (step S31).

Next, the inter prediction section 40b narrows down candidate modes of the inter prediction for the enhancement layer based on the prediction mode of the base layer indicated by the acquired prediction mode information (step S32).

Next, the inter prediction section 40b generates a predicted image according to each of candidate modes narrowed down based on the prediction mode of the base layer in step S32 (step S33).

In the mapping example shown in FIG. 8A, a plurality of candidate modes is present in the enhancement layer no matter which prediction mode is selected in the base layer. Thus, the inter prediction section 40b next evaluates the cost calculated based on original image data and predicted image data to select the optimum prediction mode (step S34).

Next, the inter prediction section 40b generates prediction mode information indicating the prediction mode selected from among narrowed-down candidate modes (step S35). If, in the mapping example shown in FIG. 8B, only one candidate mode is present, the one candidate mode is selected as the optimum prediction mode and prediction mode information is not generated.

### 4. Configuration Example of Decoding Section According to an Embodiment

[4-1. Overall Configuration Example]

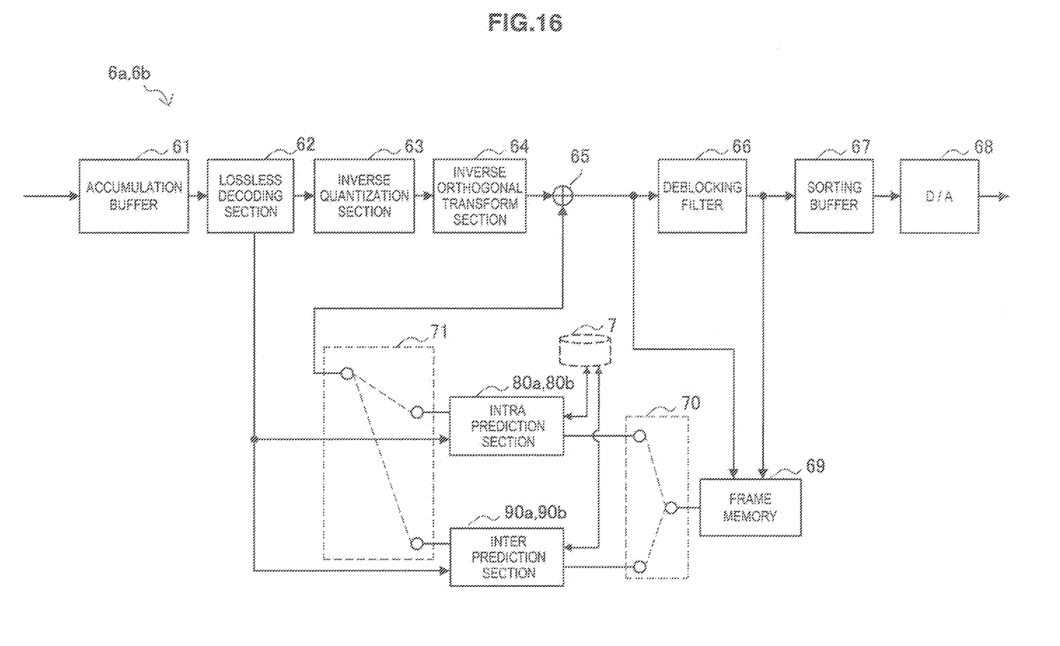

FIG. 16 is a block diagram showing an example of the configuration of the first decoding section 6a and the second decoding section 6b shown in FIG. 10. Referring to FIG. 16, the first decoding section 6a includes an accumulation buffer 61, a lossless decoding section 62, an inverse quantization section 63, an inverse orthogonal transform section 64, an addition section 65, a deblocking filter 66, a sorting buffer 67, a D/A (Digital to Analogue) conversion section 68, a frame memory 69, selectors 70, 71, an intra prediction section 80a, and an inter prediction section 90a. The second decoding section 6b includes an intra prediction section 80b instead of the intra prediction section 80a, and an inter prediction section 90b instead of the inter prediction section 90a.

The accumulation buffer 61 temporarily accumulates an encoded stream input via a transmission path using a storage medium.

The lossless decoding section 62 decodes an encoded stream of the base layer input from the accumulation buffer 61 according to the coding scheme used at the time of encoding. The lossless decoding section 62 also decodes information multiplexed in the header region of the encoded stream. The information decoded by the lossless decoding section 62 may contain, for example, the information about intra prediction and the information about inter prediction described above. The lossless decoding section 62 outputs the information about intra prediction to the intra prediction section 80a or 80b. The lossless decoding section 62 also outputs the information about inter prediction to the inter prediction section 90a or 90b.

The inverse quantization section 63 inversely quantizes quantized data which has been decoded by the lossless decoding section 62. The inverse orthogonal transform section 64 generates predicted error data by performing inverse orthogonal transformation on transform coefficient data input from the inverse quantization section 63 according to the orthogonal transformation method used at the time of encoding. Then, the inverse orthogonal transform section 64 outputs the generated predicted error data to the addition section 65.

The addition section 65 adds the predicted error data input from the inverse orthogonal transform section 64 and predicted image data input from the selector 71 to thereby generate decoded image data. Then, the addition section 65 outputs the generated decoded image data to the deblocking filter 66 and the frame memory 69.

The deblocking filter 66 removes block distortion by filtering the decoded image data input from the addition section 65, and outputs the decoded image data after filtering to the sorting buffer 67 and the frame memory 69.

The sorting buffer 67 generates a series of image data in a time sequence by sorting images input from the deblocking filter 66. Then, the sorting buffer 67 outputs the generated image data to the D/A conversion section 68.

The D/A conversion section 68 converts the image data in a digital format input from the sorting buffer 67 into an image signal in an analogue format. Then, the D/A conversion section 68 causes an image to be displayed by outputting the analogue image signal to a display (not shown) connected to the image decoding device 60, for example.

The frame memory 69 stores, using a storage medium, the decoded image data before filtering input from the addition section 65, and the decoded image data after filtering input from the deblocking filter 66.

The selector 70 switches the output destination of the image data from the frame memory 69 between the intra prediction section 80a or 80b and the inter prediction section 90a or 90b for each block in the image according to mode information acquired by the lossless decoding section 62. For example, when the intra prediction mode is specified, the selector 70 outputs the decoded image data before filtering supplied from the frame memory 69 to the intra prediction section 80a or 80b as reference image data. When the inter prediction mode is specified, the selector 70 outputs the decoded image data after filtering supplied from the frame memory 69 to the inter prediction section 90a or 90b as reference image data.

The selector 71 switches the output source of predicted image data to be supplied to the addition section 65 between the intra prediction section 80a or 80b and the inter prediction section 90a or 90b according to mode information acquired by the lossless decoding section 62. For example, when the intra prediction mode is specified, the selector 71 supplies the predicted image data output from the intra prediction section 80a or 80b to the addition section 65. When the inter prediction mode is specified, the selector 71 supplies the predicted image data output from the inter prediction section 90a or 90b to the addition section 65.

The intra prediction section 80a performs an intra prediction process of the base layer based on the information about intra prediction input from the lossless decoding section 62 and the reference image data from the frame memory 69, and generates predicted image data. Then, the intra prediction section 80a outputs the generated predicted image data of the base layer to the selector 71. Also, the intra prediction section 80a causes the common memory 7 to buffer prediction mode information.

The intra prediction section 80b performs an intra prediction process of an enhancement layer based on the information about intra prediction input from the lossless decoding section 62 and the reference image data from the frame memory 69, and generates predicted image data. Then, the intra prediction section 80b outputs the generated predicted image data of the enhancement layer to the selector 71. The intra prediction section 80b also acquires prediction mode information of the base layer buffered by the common memory 7. The prediction mode information of the base layer represents one of prediction modes in the prediction mode set supported by AVC for each prediction block. Based on such prediction mode information, the intra prediction section 80b narrows down prediction modes (prediction modes in the prediction mode set supported by HEVC) specified for the intra prediction process of the enhancement layer.

The inter prediction section 90a performs a motion compensation process of the base layer based on information about the inter prediction input from the lossless decoding section 62 and reference image data from the frame memory 69, and generates predicted image data. Then, the inter prediction section 90a outputs the generated predicted image data of the base layer to the selector 71. The inter prediction section 90a also causes the common memory 7 to buffer the prediction mode information and reference image information.

The inter prediction section 90b performs a motion compensation process of the enhancement layer based on information about the inter prediction input from the lossless decoding section 62 and reference image data from the frame memory 69, and generates predicted image data. Then, the inter prediction section 90a outputs the generated predicted image data of the enhancement layer to the selector 71. The inter prediction section 90b also acquires prediction mode information of the base layer buffered by the common memory 7. The prediction mode information of the base layer represents one of prediction modes in the prediction mode set supported by AVC for each prediction block. Based on such prediction mode information, the inter prediction section 90b narrows down prediction modes (prediction modes in the prediction mode set supported by HEVC) specified in the motion compensation process of the enhancement layer.

The first decoding section 6a performs a series of decoding processes described here on a sequence of image data of the base layer. The second decoding section 6b performs a series of decoding processes described here on a sequence of image data of the enhancement layer. When a plurality of enhancement layers is present, the decoding process of the enhancement layer can be repeated as many times as the number of enhancement layers. The decoding process of the base layer and that of an enhancement layer may be performed by being synchronized in the processing unit, for example, the decoding unit or the prediction unit.

[4-2. Detailed Configuration of Intra Prediction Section]

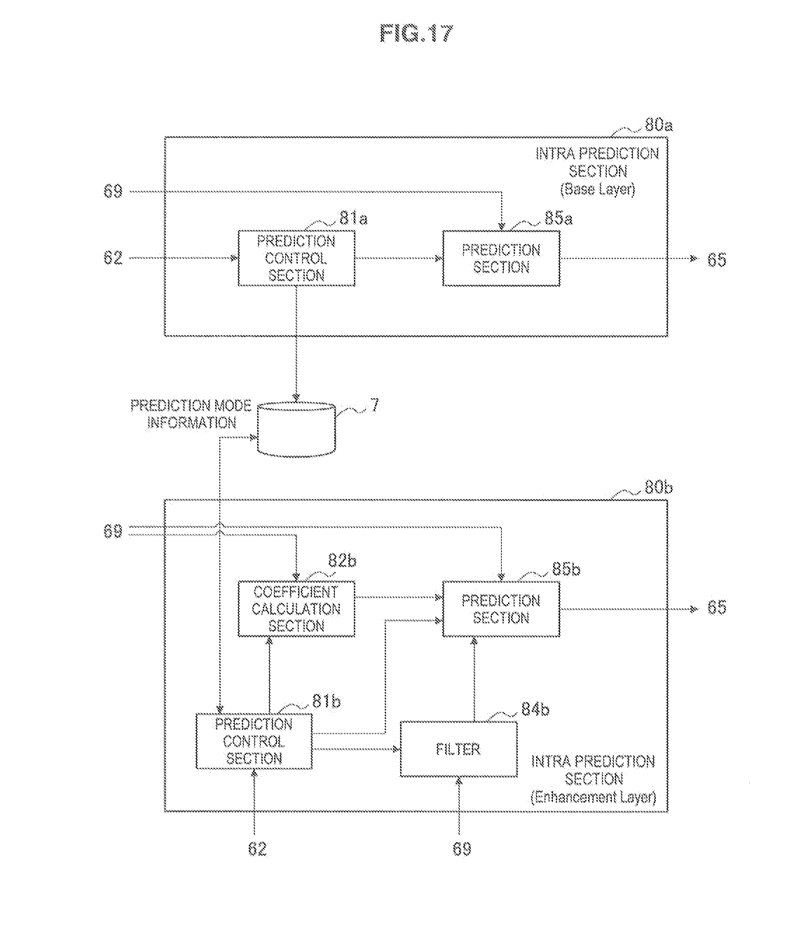

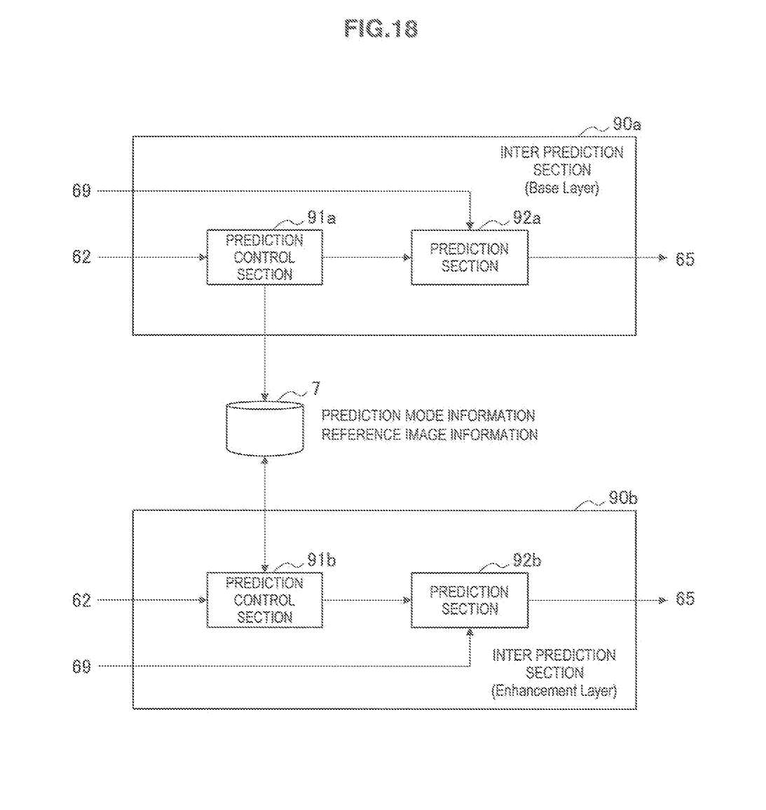

FIG. 17 is a block diagram showing an example of the detailed configuration of the intra prediction sections 80a, 80b shown in FIG. 16. Referring to FIG. 17, the intra prediction section 80a includes a prediction control section 81a and a prediction section 85a. The intra prediction section 80b includes a prediction control section 81b, a coefficient calculation section 82b, a filter 84b, and a prediction section 85b.

(1) Intra Prediction Process of the Base Layer

The prediction control section 81a of the intra prediction section 80a controls the intra prediction process of the base layer according to specifications of AVC. For example, the prediction control section 81a performs the intra prediction process of each color component for each prediction block.

More specifically, the prediction control section 81a acquires prediction mode information of the base layer input from the lossless decoding section 62. The prediction mode information indicates one of the prediction modes in the prediction mode set PMS1 illustrated in FIG. 6. The prediction section 85a generates a predicted image of each prediction block according to the prediction mode indicated by the prediction mode information. Then, the prediction section 85a outputs the generated predicted image data to the selector 71.

The prediction control section 81a stores the prediction mode information indicating the prediction mode specified for each prediction block in the base layer in the mode information buffer provided in the common memory 7.

(2) Intra Prediction Process for an Enhancement Layer

The prediction control section 81b of the intra prediction section 80b controls the intra prediction process of an enhancement layer according to specifications of HEVC. For example, the prediction control section 81b performs the intra prediction process of each color component for each prediction block.

More specifically, the prediction control section 81b narrows down candidate modes for the enhancement layer based on prediction mode information of the base layer (or a lower layer) acquired from the mode information buffer. Each candidate mode is one of the prediction modes in the prediction mode set PMS2 illustrated in FIG. 6. If one candidate mode remains after narrowing down, the prediction control section 81b selects the one candidate mode. On the other hand, if a plurality of candidate modes is present after narrowing down, the prediction control section 81b selects one candidate mode from the plurality of candidate modes based on prediction mode information of the enhancement layer input from the lossless decoding section 62. The prediction section 85b generates a predicted image of each prediction block according to the prediction mode selected by the prediction control section 81b. Then, the prediction section 85b outputs the generated predicted image data to the selector 71.

The coefficient calculation section 82b calculates coefficient of a prediction function used by the prediction section 85b in LM mode according to Formula (7) and Formula (8) described above. The filter 84b generates an input value into the prediction function in LM mode by down-sampling pixel values of the luminance component in accordance with the chroma format.

Narrowing down of prediction modes of the enhancement layer based on the prediction mode of the base layer may be performed according to, for example, the mapping shown in FIG. 6.

It is also assumed that, for example, the block size of the attention PU of the luminance component is 16×16 pixels and the block size of the corresponding prediction block in the base layer is 8×8 pixels. When the prediction mode information of the base layer indicates that the DC prediction mode is specified for the corresponding block, candidate modes are narrowed down to the DC prediction mode and the planar prediction mode. In this case, the prediction control section 81b selects, from the DC prediction mode and the planar prediction mode, the prediction mode specified by the prediction mode information of the enhancement layer. The prediction mode information may be 1 bit at most.

It is also assumed that, for example, the block size of the attention PU of the luminance component is 32×32 pixels and the block size of the corresponding prediction block is 16×16 pixels. When the prediction mode information of the base layer indicates that the DC prediction mode is specified for the corresponding block, candidate modes are narrowed down to the DC prediction mode only. When the prediction mode information of the base layer indicates that the planar prediction mode is specified for the corresponding block in the same case, candidate modes are narrowed down to the planar prediction mode only. In this case, the prediction control section 81b may not acquire the prediction mode information of the enhancement layer.

When, for example, the prediction mode information of the base layer indicates that a prediction mode associated with a specific prediction mode is selected for the corresponding block corresponding to the attention PU of the luminance component, candidate modes are narrowed down to the angular prediction modes. Further, the prediction direction in angular prediction mode can be narrowed down to a range close to the prediction direction of the prediction mode of the base layer. In this case, the prediction control section 81b determines the prediction direction of the prediction mode to be determined using a difference between the prediction direction of the prediction mode of the base layer and the prediction direction specified by the prediction mode information of the enhancement layer. Then, the prediction control section 81b selects the prediction mode corresponding to the determined prediction direction for the attention PU.

Also, for the attention PU of the color difference component, for example, candidate modes are narrowed down to the prediction mode selected for the corresponding block in the base layer and the LM mode. In this case, the prediction control section 81b selects, from the prediction mode specified for the corresponding block in the base layer and the LM mode, the prediction mode specified by the prediction mode information of the enhancement layer. The prediction mode information may be 1 bit at most.

When a higher layer is present, the prediction control section 81b may store prediction mode information for each prediction unit in the mode information buffer.

[4-3. Detailed Configuration of Inter Prediction Section]

FIG. 18 is a block diagram showing an example of a detailed configuration of the inter prediction sections 90a, 90b shown in FIG. 16. Referring to FIG. 18, the inter prediction section 90a includes a prediction control section 91a and a prediction section 92a. The inter prediction section 90b includes a prediction control section 91b and a prediction section 92b.

(1) Motion Compensation Process of the Base Layer

The prediction control section 91a of the inter prediction section 90a controls the motion compensation process of the base layer according to specifications of AVC. For example, the prediction control section 91a performs the motion compensation process of each color component for each prediction block.

More specifically, the prediction control section 91a acquires prediction mode information of the base layer input from the lossless decoding section 62. The prediction mode information indicates one of the prediction modes in the prediction mode set PMS3 illustrated in FIG. 8A or 8B. The prediction section 92a generates a predicted image of each prediction block according to the prediction mode indicated by the prediction mode information. Then, the prediction section 92a outputs the generated predicted image data to the selector 71.

The prediction control section 91a stores the prediction mode information indicating the prediction mode specified for each prediction block in the base layer and reference image information in the motion information buffer provided in the common memory 7.

(2) Motion Compensation Process of an Enhancement Layer

The prediction control section 91b of the inter prediction section 90b controls the motion compensation process of an enhancement layer according to specifications of HEVC. For example, the prediction control section 91b performs the motion compensation process of each color component for each prediction unit.

More specifically, the prediction control section 91b narrows down candidate modes for the enhancement layer based on prediction mode information of the base layer (or a lower layer) acquired from the motion information buffer. Each candidate mode is one of the prediction modes in the prediction mode set PMS4 illustrated in FIG. 8A or 8B. The prediction control section 81b selects one candidate mode from a plurality of narrowed-down candidate modes based on prediction mode information of the enhancement layer input from the lossless decoding section 62. The prediction section 92b generates a predicted image of each prediction block according to the prediction mode selected by the prediction control section 91b. A reference image can be determined according to reference image information acquired from the motion information buffer. Then, the prediction section 92b outputs the generated predicted image data to the selector 71.

Narrowing down of prediction modes of the enhancement layer based on the prediction mode of the base layer may be performed according to, for example, the mapping shown in FIG. 8A or 8B.

When, for example, the prediction mode information of the base layer indicates that the space direct mode is selected for the corresponding block in the base layer, candidate modes for the attention PU are narrowed down to the space merge mode and the spatial motion vector prediction mode. In this case, the prediction control section 91b selects, from the space merge mode and the spatial motion vector prediction mode, the prediction mode specified by the prediction mode information of the enhancement layer. Instead, when the prediction mode information of the base layer indicates that the space direct mode is selected for the corresponding block in the base layer, the space merge mode may be selected as the prediction mode of the attention PU without referring to the prediction mode information.

When, for example, the prediction mode information of the base layer indicates that the time direct mode is selected for the corresponding block in the base layer, candidate modes for the attention PU are narrowed down to the time merge mode and the time motion vector prediction mode. In this case, the prediction control section 91b selects a prediction mode specified by the prediction mode information of the enhancement layer from a time merge mode and a predicted image in time motion vector prediction mode. Instead, when the prediction mode information of the base layer indicates that the time direct mode is selected for the corresponding block in the base layer, the time merge mode may be selected as the prediction mode of the attention PU, without referring to the prediction mode information.

When, for example, the prediction mode information of the base layer indicates that the skip mode is selected for the corresponding block in the base layer, prediction modes for the attention PU may be narrowed down to the space merge mode and the time merge mode. In this case, the prediction control section 91b selects, from the space merge mode and the time merge mode, the prediction mode specified by the prediction mode information of the enhancement layer.

When, for example, the prediction mode information of the base layer indicates that a non-direct mode is selected for the corresponding block in the base layer, the prediction control section 91b can select, of all prediction modes supported by HEVC, the prediction mode specified by the prediction mode information of the enhancement layer without candidate modes for the attention PU being narrowed down. Like the example shown in FIG. 8B, candidate modes for the attention PU may be narrowed down depending on whether the direct mode or the skip mode is selected for the corresponding block in the base layer.

Further, for example, the reference direction may be reused between layers. In this case, the prediction control section 91b can cause the prediction section 92b to generate a predicted image according to the reference direction (the L0 prediction, L1 prediction, or bidirectional prediction) used for the corresponding block in the base layer.

When a higher layer is present, the prediction control section 91b may store prediction mode information for each prediction unit in the motion information buffer.

### 5. Process Flow for Decoding According to an Embodiment

(1) Schematic Flow

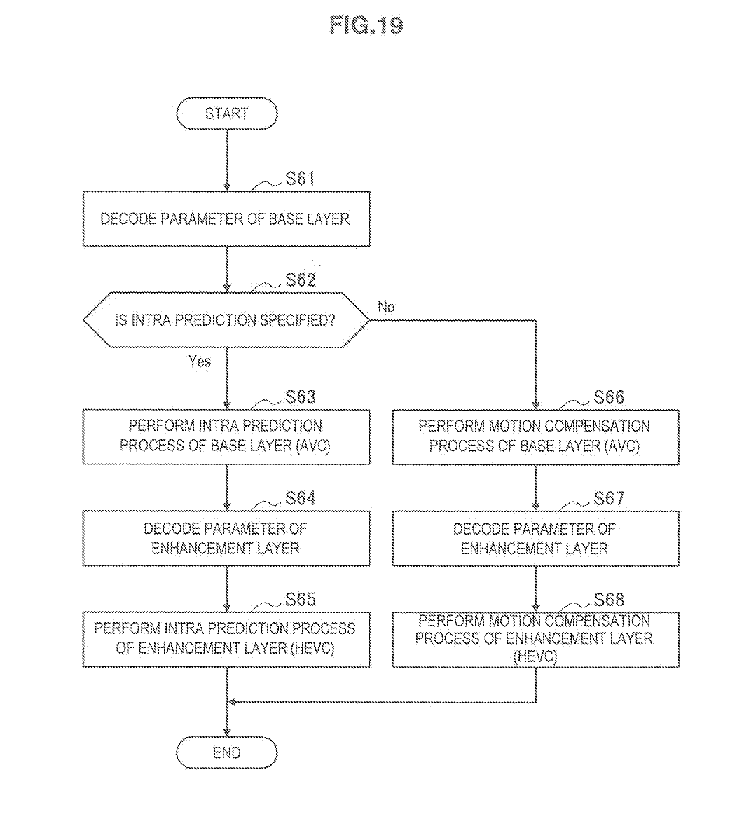

FIG. 19 is a flow chart showing an example of a schematic process flow for decoding according to an embodiment. For the sake of brevity of description, process steps that are not directly related to technology according to the present disclosure are omitted from FIG. 19.

Referring to FIG. 19, the lossless decoding section 62 first decodes an encoded parameter of the base layer (step S61). The subsequent process branches depending on whether the intra prediction mode or the inter prediction mode is specified for each block based on the decoded parameter (step S62).

The intra prediction section 80a for the base layer performs the intra prediction process of the base layer according to the prediction mode specified by the prediction mode information on a prediction block for which the intra prediction mode is specified (step S63). The intra prediction section 80a stores prediction mode information for each prediction block in the common memory 7.

Next, the lossless decoding section 62 decodes an encoded parameter of the enhancement layer (step S64). Then, the intra prediction section 80b of the enhancement layer performs the intra prediction process on the corresponding prediction unit in the enhancement layer (step S65). Candidates of the prediction mode here are narrowed down based on prediction mode information of the base layer acquired from the common memory 7.

The inter prediction section 90a for the base layer performs the motion compensation process of the base layer according to prediction mode information and reference image information on a prediction block for which the inter prediction mode is specified (step S66). The inter prediction section 90a stores prediction mode information for each prediction block and reference image information in the common memory 7.

Next, the lossless decoding section 62 decodes an encoded parameter of the enhancement layer (step S67). Then, the inter prediction section 90b of the enhancement layer performs the motion compensation process on the corresponding prediction unit in the enhancement layer (step S68). Candidates of the prediction mode here are narrowed down based on prediction mode information of the base layer acquired from the common memory 7. Reference image information can also be reused.

(2) Intra Prediction Process for an Enhancement Layer

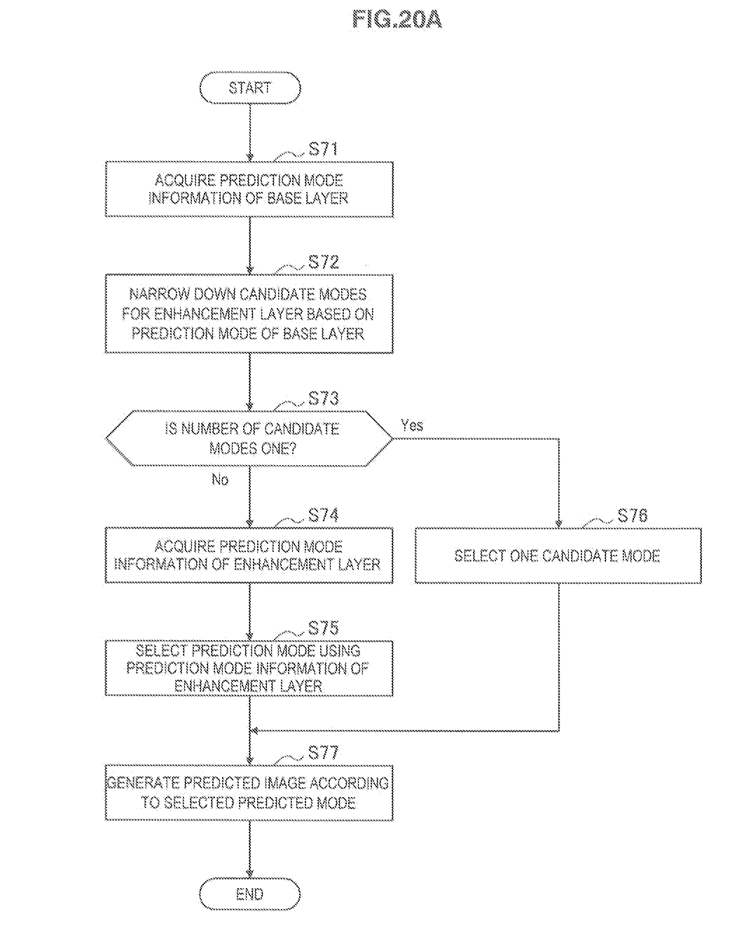

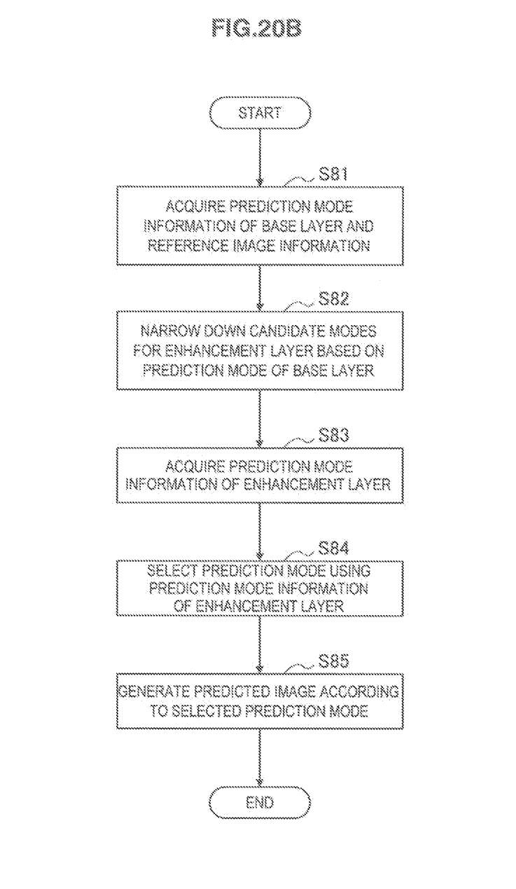

FIG. 20A is a flow chart showing an example of the detailed flow of the intra prediction process for the enhancement layer during decoding corresponding to step S65 in FIG. 19.

Referring to FIG. 20A, the intra prediction section 80b first acquires prediction mode information of the base layer buffered by the common memory 7 (step S71).

Next, the intra prediction section 80b narrows down candidate modes of the intra prediction for the enhancement layer based on the prediction mode of the base layer indicated by the acquired prediction mode information (step S72). The subsequent process branches depending on whether a plurality of candidate modes after narrowing down is present (step S73).

When the plurality of candidate modes after narrowing down is present, the intra prediction section 80b acquires prediction mode information of the enhancement layer (step S74). Then, the intra prediction section 80b selects, among candidate modes after narrowing down, the prediction mode indicated by the prediction mode information of the enhancement layer (step S75).

On the other hand, when only one candidate mode is present after narrowing down, the intra prediction section 80b selects the one candidate mode (step S76). In this case, the prediction mode information of the enhancement layer is not acquired.

Then, the intra prediction section 80b generates a predicted image according to the prediction mode selected in step S75 or S76 (step S77).

(3) Motion Compensation Process for an Enhancement Layer

FIG. 20B is a flow chart showing an example of the detailed flow of the motion compensation process for the enhancement layer during decoding corresponding to step S68 in FIG. 19.

Referring to FIG. 20B, the inter prediction section 90b first acquires prediction mode information of the base layer and reference image information buffered by the common memory 7 (step S81).

Next, the inter prediction section 90b narrows down candidate modes of the inter prediction for the enhancement layer based on the prediction mode of the base layer indicated by the acquired prediction mode information (step S82).

In the mapping example shown in FIG. 8A, a plurality of candidate modes is present in the enhancement layer no matter which prediction mode is selected in the base layer. Thus, the inter prediction section 90b further acquires prediction mode information of the enhancement layer (step S83). Then, the inter prediction section 90b selects, among candidate modes after narrowing down, the prediction mode indicated by the prediction mode information of the enhancement layer (step S84).

Then, the inter prediction section 90b generates a predicted image according to the prediction mode selected in step S84 and reference image information that can be reused (step S85). If only one candidate mode is present in the example shown in FIG. 8B, the inter prediction section 90b may generate a predicted image according to the one candidate mode and the reference image information.

### 6. Modification

[6-1. Extension of Prediction Mode]

The prediction mode set supported in an enhancement layer may not match the prediction mode set supported for normal encoding of the base layer. A prediction mode extended by utilizing a feature of an enhancement layer that a lower layer is present may be supported in the enhancement layer.

In the inter prediction in HEVC, as was described using, for example, FIGS. 8A and 8B, a plurality of prediction modes including the merge mode and the motion vector prediction mode is supported. A candidate predicted motion vector of the attention PU predicted (AMVP mode) or acquired (merge mode) in the i-th prediction mode is set as PMVᵢ. Also, a motion vector used for the corresponding block in the base layer is set as MV_{base}. In the prediction mode extended as an example, the predicted motion vector PMVe used for the attention PU may be determined by Formula (9) and Formula (10) shown below. A number k is, as shown in Formula (9), the number of the prediction mode corresponding to the candidate predicted motion vector showing the smallest difference from the motion vector MV_{base},

$$\begin{matrix}[ Math . 7 ] \\ k = {arg min \vert {PMV}_{i} - {MV}_{base} \vert}_{i} & ( 9 ) \\ PMVe = {PMV}_{k} & ( 10 )\end{matrix}$$

If the spatial resolution is different between the base layer and the enhancement layer, Formula (9) shown above may be evaluated after scaling the motion vector MV_{base} in accordance with the resolution ratio. If the reference index corresponding to the motion vector MV_{base} and the reference index corresponding to the i-th prediction mode are different, Formula (9) shown above may be evaluated after scaling the motion vector MV_{base} based on a difference of the reference index. The reference index may include a merge index and an AMVP index described in, for example, “Parsing Robustness for Merge/AMVP” (Toshiyasu Sugio. Takahiro Nishi, JCTVC-F470). Thanks to the above scaling, even if the motion vector is calculated in a state in which the spatial resolution or the temporal position of reference images is different, such motion vectors can appropriately be compared to determine the optimum prediction mode.

It is assumed in general that when compared with a motion vector in neighboring blocks, a motion vector of the corresponding block in the base layer is closer to an ideal motion vector for the attention PU in the enhancement layer. Thus, by selecting, as described above, the predicted motion vector showing the smallest difference to the motion vector MV_{base}, the prediction precision of the motion vector in the enhancement layer can be improved and the encoding efficiency can be enhanced. The motion vector MV_{base} of the base layer is typically buffered by using a common memory. The motion vector MV_{base} may be thinned out during buffering to curb the consumption of memory resources. Instead, the motion vector MV_{base} may be re-estimated from a reconstructed image of the base layer without being buffered. The technique of re-estimation is particularly useful for scalable video coding of the type of the BLR (spatial scalability using BL Reconstructed pixel only) mode.

If a plurality of prediction modes (a plurality of solutions of k) corresponding to the predicted motion vector showing the smallest difference to the motion vector MV_{base} is present in Formula (9), the prediction mode having the same reference index as that corresponding to the motion vector MV_{base} may be selected for the inter prediction of the enhancement layer. Accordingly, a highly precise predicted image can be generated in the enhancement layer using a reference image equal in quality to that of the base layer. If the number of prediction modes having the same reference index as that corresponding to the motion vector MV_{base} is not one (for example, two or more, or zero), the prediction mode of the smallest reference index of the plurality of prediction modes showing the smallest difference may be selected for the inter prediction of the enhancement layer. Instead, a parameter indicating which prediction mode of the plurality of prediction modes may be encoded by an encoder inside an encoded stream of the enhancement layer and decoded by a decoder.

[6-2. Switching in Accordance with Combination of Encoding Methods]

Heretofore, examples in which the base layer is encoded in AVC and an enhancement layer is encoded in HEVC have mainly been described. However, for example, ideas such as the reuse of the reference direction between layers and an extended prediction mode described using Formula (9) and Formula (10) are generally applicable to scalable video coding in which an enhancement layer is encoded in HEVC. The encoding method of the base layer may be AVC or HEVC.

In JCTVC, coding of a flag indicating the encoding method used for the base layer in VPS (Video Parameter Set) is being discussed (see, for example, “NAL unit header and parameter set designs for HEVC extensions” (Jill Boyce, Ye-Kui Wang, JCTVC-K1007)). The flag can show “1” when AVC is used for the base layer and “0” otherwise. Individual ideas described above may be enabled or disabled in accordance with the value of the flag decoded from VPS.

If, for example, AVC is indicated as the encoding method of the base layer (the encoding method of the enhancement layer is HEVC), prediction modes for the enhancement layer may be narrowed down according to technology in the present disclosure. On the other hand, if the encoding method is HEVC for both of the base layer and the enhancement layer, the prediction mode (for example, the merge mode or the AMVP mode) specified for the corresponding block in the base layer may directly selected (reused) for the attention PU in the enhancement layer.

Instead, for example, if the encoding method is HEVC for both of the base layer and the enhancement layer, the prediction mode specified in the base layer may be reused in the enhancement layer and if the encoding method of the base layer is AVC, prediction mode information and other information (for example, motion information) may be encoded in the enhancement layer in the same manner as normal encoding of a single layer. In the latter case, the inter prediction of the enhancement layer is made in the prediction mode decoded from an encoded stream of the enhancement layer without referring to motion information of the base layer.

In both of AVC and HEVC, the arrangement of an intra prediction block in a P picture and a B picture (picture in which an inter prediction can be made) is permitted. Thus, when the intra prediction is made for the corresponding block in the base layer regardless of the picture type of the enhancement layer, the intra prediction may be made for the attention PU in the enhancement layer. Instead, when the intra prediction is made for the corresponding block in the base layer, motion information may separately be encoded for the attention PU in a P picture or a B picture of the enhancement layer. In the latter case, the inter prediction of the enhancement layer is made using the motion information decoded from an encoded stream of the enhancement layer.

Flexible design of prediction processes in accordance with uses of scalable video coding is enabled by switching of the prediction processes as described herein so that the encoding efficiency can further be enhanced by improving the prediction precision of an enhancement layer.

### 7. Example Application

[7-1. Application to Various Products]

The image encoding device 10 and the image decoding device 60 according to the embodiment described above may be applied to various electronic appliances such as a transmitter and a receiver for satellite broadcasting, cable broadcasting such as cable TV, distribution on the Internet, distribution to terminals via cellular communication, and the like, a recording device that records images in a medium such as an optical disc, a magnetic disk or a flash memory, a reproduction device that reproduces images from such storage medium, and the like. Four example applications will be described below.

### (1) First Application Example

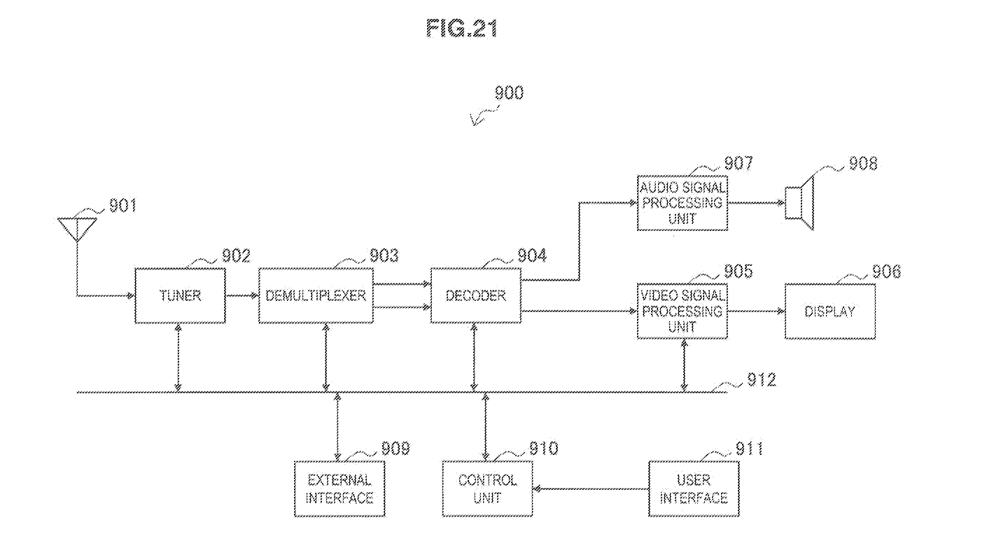

FIG. 21 is a diagram illustrating an example of a schematic configuration of a television device applying the aforementioned embodiment. A television device 900 includes an antenna 901, a tuner 902, a demultiplexer 903, a decoder 904, a video signal processing unit 905, a display 906, an audio signal processing unit 907, a speaker 908, an external interface 909, a control unit 910, a user interface 911, and a bus 912.

The tuner 902 extracts a signal of a desired channel from a broadcast signal received through the antenna 901 and demodulates the extracted signal. The tuner 902 then outputs an encoded bit stream obtained by the demodulation to the demultiplexer 903. That is, the tuner 902 has a role as transmission means receiving the encoded stream in which an image is encoded, in the television device 900.

The demultiplexer 903 isolates a video stream and an audio stream in a program to be viewed from the encoded bit stream and outputs each of the isolated streams to the decoder 904. The demultiplexer 903 also extracts auxiliary data such as an EPG (Electronic Program Guide) from the encoded bit stream and supplies the extracted data to the control unit 910. Here, the demultiplexer 903 may descramble the encoded bit stream when it is scrambled.

The decoder 904 decodes the video stream and the audio stream that are input from the demultiplexer 903. The decoder 904 then outputs video data generated by the decoding process to the video signal processing unit 905. Furthermore, the decoder 904 outputs audio data generated by the decoding process to the audio signal processing unit 907.

The video signal processing unit 905 reproduces the video data input from the decoder 904 and displays the video on the display 906. The video signal processing unit 905 may also display an application screen supplied through the network on the display 906. The video signal processing unit 905 may further perform an additional process such as noise reduction on the video data according to the setting. Furthermore, the video signal processing unit 905 may generate an image of a GUI (Graphical User Interface) such as a menu, a button, or a cursor and superpose the generated image onto the output image.

The display 906 is driven by a drive signal supplied from the video signal processing unit 905 and displays video or an image on a video screen of a display device (such as a liquid crystal display, a plasma display, or an OELD (Organic ElectroLuminescence Display)).

The audio signal processing unit 907 performs a reproducing process such as D/A conversion and amplification on the audio data input from the decoder 904 and outputs the audio from the speaker 908. The audio signal processing unit 907 may also perform an additional process such as noise reduction on the audio data.

The external interface 909 is an interface that connects the television device 900 with an external device or a network. For example, the decoder 904 may decode a video stream or an audio stream received through the external interface 909. This means that the external interface 909 also has a role as the transmission means receiving the encoded stream in which an image is encoded, in the television device 900.

The control unit 910 includes a processor such as a CPU and a memory such as a RAM and a ROM. The memory stores a program executed by the CPU, program data, EPG data, and data acquired through the network. The program stored in the memory is read by the CPU at the start-up of the television device 900 and executed, for example. By executing the program, the CPU controls the operation of the television device 900 in accordance with an operation signal that is input from the user interface 911, for example.

The user interface 911 is connected to the control unit 910. The user interface 911 includes a button and a switch for a user to operate the television device 900 as well as a reception part which receives a remote control signal, for example. The user interface 911 detects a user operation through these components, generates the operation signal, and outputs the generated operation signal to the control unit 910.

The bus 912 mutually connects the tuner 902, the demultiplexer 903, the decoder 904, the video signal processing unit 905, the audio signal processing unit 907, the external interface 909, and the control unit 910.

The decoder 904 in the television device 900 configured in the aforementioned manner has a function of the image decoding device 60 according to the aforementioned embodiment. Accordingly, for scalable video decoding of images by the television device 900, also when a plurality of layers is encoded by different image encoding methods in scalable video coding, the code amount needed for prediction mode information can be reduced.

### (2) Second Application Example

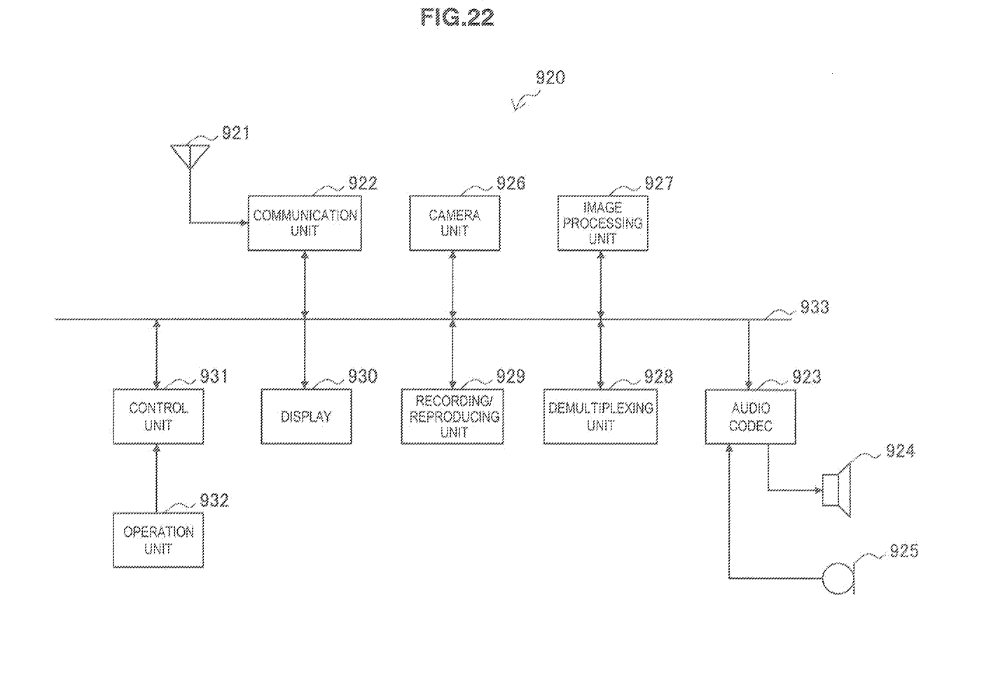

FIG. 22 is a diagram illustrating an example of a schematic configuration of a mobile telephone applying the aforementioned embodiment. A mobile telephone 920 includes an antenna 921, a communication unit 922, an audio codec 923, a speaker 924, a microphone 925, a camera unit 926, an image processing unit 927, a demultiplexing unit 928, a recording/reproducing unit 929, a display 930, a control unit 931, an operation unit 932, and a bus 933.

The antenna 921 is connected to the communication unit 922. The speaker 924 and the microphone 925 are connected to the audio codec 923. The operation unit 932 is connected to the control unit 931. The bus 933 mutually connects the communication unit 922, the audio codec 923, the camera unit 926, the image processing unit 927, the demultiplexing unit 928, the recording/reproducing unit 929, the display 930, and the control unit 931.

The mobile telephone 920 performs an operation such as transmitting/receiving an audio signal, transmitting/receiving an electronic mail or image data, imaging an image, or recording data in various operation modes including an audio call mode, a data communication mode, a photography mode, and a videophone mode.

In the audio call mode, an analog audio signal generated by the microphone 925 is supplied to the audio codec 923. The audio codec 923 then converts the analog audio signal into audio data, performs A/D conversion on the converted audio data, and compresses the data. The audio codec 923 thereafter outputs the compressed audio data to the communication unit 922. The communication unit 922 encodes and modulates the audio data to generate a transmission signal. The communication unit 922 then transmits the generated transmission signal to a base station (not shown) through the antenna 921. Furthermore, the communication unit 922 amplifies a radio signal received through the antenna 921, converts a frequency of the signal, and acquires a reception signal. The communication unit 922 thereafter demodulates and decodes the reception signal to generate the audio data and output the generated audio data to the audio codec 923. The audio codec 923 expands the audio data, performs D/A conversion on the data, and generates the analog audio signal. The audio codec 923 then outputs the audio by supplying the generated audio signal to the speaker 924.

In the data communication mode, for example, the control unit 931 generates character data configuring an electronic mail, in accordance with a user operation through the operation unit 932. The control unit 931 further displays a character on the display 930. Moreover, the control unit 931 generates electronic mail data in accordance with a transmission instruction from a user through the operation unit 932 and outputs the generated electronic mail data to the communication unit 922. The communication unit 922 encodes and modulates the electronic mail data to generate a transmission signal. Then, the communication unit 922 transmits the generated transmission signal to the base station (not shown) through the antenna 921. The communication unit 922 further amplifies a radio signal received through the antenna 921, converts a frequency of the signal, and acquires a reception signal. The communication unit 922 thereafter demodulates and decodes the reception signal, restores the electronic mail data, and outputs the restored electronic mail data to the control unit 931. The control unit 931 displays the content of the electronic mail on the display 930 as well as stores the electronic mail data in a storage medium of the recording/reproducing unit 929.

The recording/reproducing unit 929 includes an arbitrary storage medium that is readable and writable. For example, the storage medium may be a built-in storage medium such as a RAM or a flash memory, or may be an externally-mounted storage medium such as a hard disk, a magnetic disk, a magneto-optical disk, an optical disk, a USB (Unallocated Space Bitmap) memory, or a memory card.

In the photography mode, for example, the camera unit 926 images an object, generates image data, and outputs the generated image data to the image processing unit 927. The image processing unit 927 encodes the image data input from the camera unit 926 and stores an encoded stream in the storage medium of the storing/reproducing unit 929.

In the videophone mode, for example, the demultiplexing unit 928 multiplexes a video stream encoded by the image processing unit 927 and an audio stream input from the audio codec 923, and outputs the multiplexed stream to the communication unit 922. The communication unit 922 encodes and modulates the stream to generate a transmission signal. The communication unit 922 subsequently transmits the generated transmission signal to the base station (not shown) through the antenna 921. Moreover, the communication unit 922 amplifies a radio signal received through the antenna 921, converts a frequency of the signal, and acquires a reception signal. The transmission signal and the reception signal can include an encoded bit stream. Then, the communication unit 922 demodulates and decodes the reception signal to restore the stream, and outputs the restored stream to the demultiplexing unit 928. The demultiplexing unit 928 isolates the video stream and the audio stream from the input stream and outputs the video stream and the audio stream to the image processing unit 927 and the audio codec 923, respectively. The image processing unit 927 decodes the video stream to generate video data. The video data is then supplied to the display 930, which displays a series of images. The audio codec 923 expands and performs D/A conversion on the audio stream to generate an analog audio signal. The audio codec 923 then supplies the generated audio signal to the speaker 924 to output the audio.

The image processing unit 927 in the mobile telephone 920 configured in the aforementioned manner has a function of the image encoding device 10 and the image decoding device 60 according to the aforementioned embodiment. Accordingly, for scalable video coding and decoding of images by the mobile telephone 920, also when a plurality of layers is encoded by different image encoding methods in scalable video coding, the code amount needed for prediction mode information can be reduced.

### (3) Third Application Example

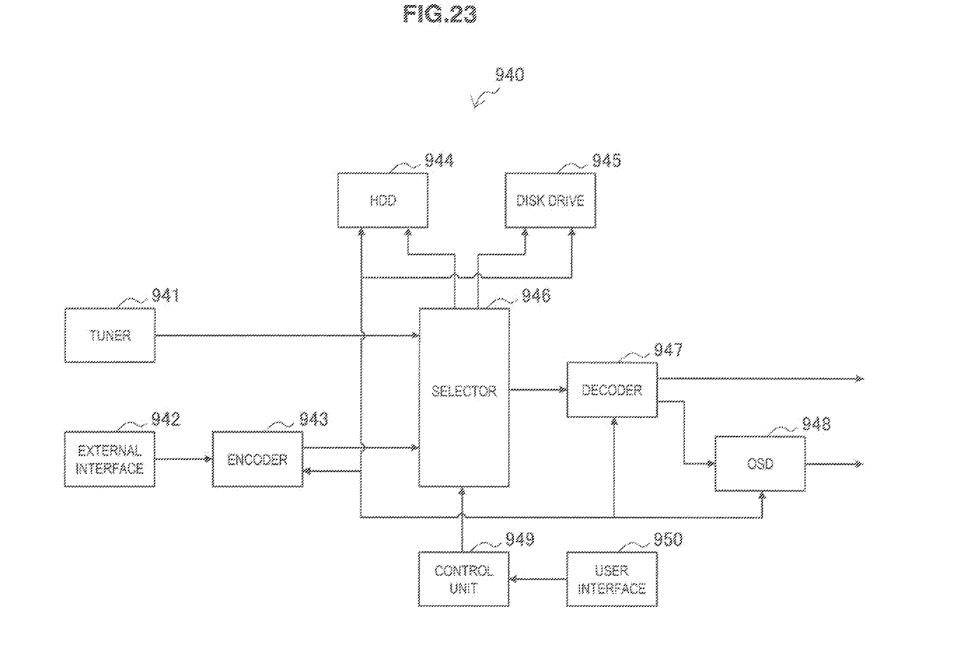

FIG. 23 is a diagram illustrating an example of a schematic configuration of a recording/reproducing device applying the aforementioned embodiment. A recording/reproducing device 940 encodes audio data and video data of a broadcast program received and records the data into a recording medium, for example. The recording/reproducing device 940 may also encode audio data and video data acquired from another device and record the data into the recording medium, for example. In response to a user instruction, for example, the recording/reproducing device 940 reproduces the data recorded in the recording medium on a monitor and a speaker. The recording/reproducing device 940 at this time decodes the audio data and the video data.

The recording/reproducing device 940 includes a tuner 941, an external interface 942, an encoder 943, an HDD (Hard Disk Drive) 944, a disk drive 945, a selector 946, a decoder 947, an OSD (On-Screen Display) 948, a control unit 949, and a user interface 950.

The tuner 941 extracts a signal of a desired channel from a broadcast signal received through an antenna (not shown) and demodulates the extracted signal. The tuner 941 then outputs an encoded bit stream obtained by the demodulation to the selector 946. That is, the tuner 941 has a role as transmission means in the recording/reproducing device 940.

The external interface 942 is an interface which connects the recording/reproducing device 940 with an external device or a network. The external interface 942 may be, for example, an IEEE 1394 interface, a network interface, a USB interface, or a flash memory interface. The video data and the audio data received through the external interface 942 are input to the encoder 943, for example. That is, the external interface 942 has a role as transmission means in the recording/reproducing device 940.

The encoder 943 encodes the video data and the audio data when the video data and the audio data input from the external interface 942 are not encoded. The encoder 943 thereafter outputs an encoded bit stream to the selector 946.

The HDD 944 records, into an internal hard disk, the encoded bit stream in which content data such as video and audio is compressed, various programs, and other data. The HDD 944 reads these data from the hard disk when reproducing the video and the audio.

The disk drive 945 records and reads data into/from a recording medium which is mounted to the disk drive. The recording medium mounted to the disk drive 945 may be, for example, a DVD disk (such as DVD-Video, DVD-RAM, DVD-R, DVD-RW, DVD+R, or DVD+RW) or a Blu-ray (Registered Trademark) disk.

The selector 946 selects the encoded bit stream input from the tuner 941 or the encoder 943 when recording the video and audio, and outputs the selected encoded bit stream to the HDD 944 or the disk drive 945. When reproducing the video and audio, on the other hand, the selector 946 outputs the encoded bit stream input from the HDD 944 or the disk drive 945 to the decoder 947.

The decoder 947 decodes the encoded bit stream to generate the video data and the audio data. The decoder 904 then outputs the generated video data to the OSD 948 and the generated audio data to an external speaker.

The OSD 948 reproduces the video data input from the decoder 947 and displays the video. The OSD 948 may also superpose an image of a GUI such as a menu, a button, or a cursor onto the video displayed.

The control unit 949 includes a processor such as a CPU and a memory such as a RAM and a ROM. The memory stores a program executed by the CPU as well as program data. The program stored in the memory is read by the CPU at the start-up of the recording/reproducing device 940 and executed, for example. By executing the program, the CPU controls the operation of the recording/reproducing device 940 in accordance with an operation signal that is input from the user interface 950, for example.

The user interface 950 is connected to the control unit 949. The user interface 950 includes a button and a switch for a user to operate the recording/reproducing device 940 as well as a reception part which receives a remote control signal, for example. The user interface 950 detects a user operation through these components, generates the operation signal, and outputs the generated operation signal to the control unit 949.

The encoder 943 in the recording/reproducing device 940 configured in the aforementioned manner has a function of the image encoding device 10 according to the aforementioned embodiment. On the other hand, the decoder 947 has a function of the image decoding device 60 according to the aforementioned embodiment. Accordingly, for scalable video coding and decoding of images by the recording/reproducing device 940, also when a plurality of layers is encoded by different image encoding methods in scalable video coding, the code amount needed for prediction mode information can be reduced.

### (4) Fourth Application Example

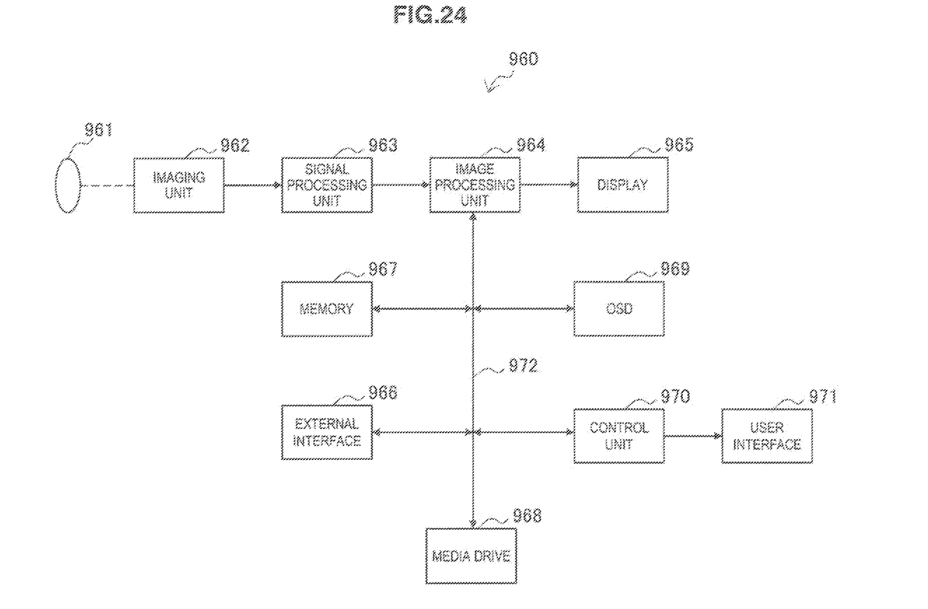

FIG. 24 shows an example of a schematic configuration of an image capturing device applying the aforementioned embodiment. An imaging device 960 images an object, generates an image, encodes image data, and records the data into a recording medium.

The imaging device 960 includes an optical block 961, an imaging unit 962, a signal processing unit 963, an image processing unit 964, a display 965, an external interface 966, a memory 967, a media drive 968, an OSD 969, a control unit 970, a user interface 971, and a bus 972.

The optical block 961 is connected to the imaging unit 962. The imaging unit 962 is connected to the signal processing unit 963. The display 965 is connected to the image processing unit 964. The user interface 971 is connected to the control unit 970. The bus 972 mutually connects the image processing unit 964, the external interface 966, the memory 967, the media drive 968, the OSD 969, and the control unit 970.

The optical block 961 includes a focus lens and a diaphragm mechanism. The optical block 961 forms an optical image of the object on an imaging surface of the imaging unit 962. The imaging unit 962 includes an image sensor such as a CCD (Charge Coupled Device) or a CMOS (Complementary Metal Oxide Semiconductor) and performs photoelectric conversion to convert the optical image formed on the imaging surface into an image signal as an electric signal. Subsequently, the imaging unit 962 outputs the image signal to the signal processing unit 963.

The signal processing unit 963 performs various camera signal processes such as a knee correction, a gamma correction and a color correction on the image signal input from the imaging unit 962. The signal processing unit 963 outputs the image data, on which the camera signal process has been performed, to the image processing unit 964.

The image processing unit 964 encodes the image data input from the signal processing unit 963 and generates the encoded data. The image processing unit 964 then outputs the generated encoded data to the external interface 966 or the media drive 968. The image processing unit 964 also decodes the encoded data input from the external interface 966 or the media drive 968 to generate image data. The image processing unit 964 then outputs the generated image data to the display 965. Moreover, the image processing unit 964 may output to the display 965 the image data input from the signal processing unit 963 to display the image. Furthermore, the image processing unit 964 may superpose display data acquired from the OSD 969 onto the image that is output on the display 965.

The OSD 969 generates an image of a GUI such as a menu, a button, or a cursor and outputs the generated image to the image processing unit 964.

The external interface 966 is configured as a USB input/output terminal, for example. The external interface 966 connects the imaging device 960 with a printer when printing an image, for example. Moreover, a drive is connected to the external interface 966 as needed. A removable medium such as a magnetic disk or an optical disk is mounted to the drive, for example, so that a program read from the removable medium can be installed to the imaging device 960. The external interface 966 may also be configured as a network interface that is connected to a network such as a LAN or the Internet. That is, the external interface 966 has a role as transmission means in the imaging device 960.

The recording medium mounted to the media drive 968 may be an arbitrary removable medium that is readable and writable such as a magnetic disk, a magneto-optical disk, an optical disk, or a semiconductor memory. Furthermore, the recording medium may be fixedly mounted to the media drive 968 so that a non-transportable storage unit such as a built-in hard disk drive or an SSD (Solid State Drive) is configured, for example.

The control unit 970 includes a processor such as a CPU and a memory such as a RAM and a ROM. The memory stores a program executed by the CPU as well as program data. The program stored in the memory is read by the CPU at the start-up of the imaging device 960 and then executed. By executing the program, the CPU controls the operation of the imaging device 960 in accordance with an operation signal that is input from the user interface 971, for example.

The user interface 971 is connected to the control unit 970. The user interface 971 includes a button and a switch for a user to operate the imaging device 960, for example. The user interface 971 detects a user operation through these components, generates the operation signal, and outputs the generated operation signal to the control unit 970.

The image processing unit 964 in the imaging device 960 configured in the aforementioned manner has a function of the image encoding device 10 and the image decoding device 60 according to the aforementioned embodiment. Accordingly, for scalable video coding and decoding of images by the imaging device 960, also when a plurality of layers is encoded by different image encoding methods in scalable video coding, the code amount needed for prediction mode information can be reduced.

[7-2. Various Uses of Scalable Video Coding]

Advantages of scalable video coding described above can be enjoyed in various uses. Three examples of use will be described below.

### (1) First example

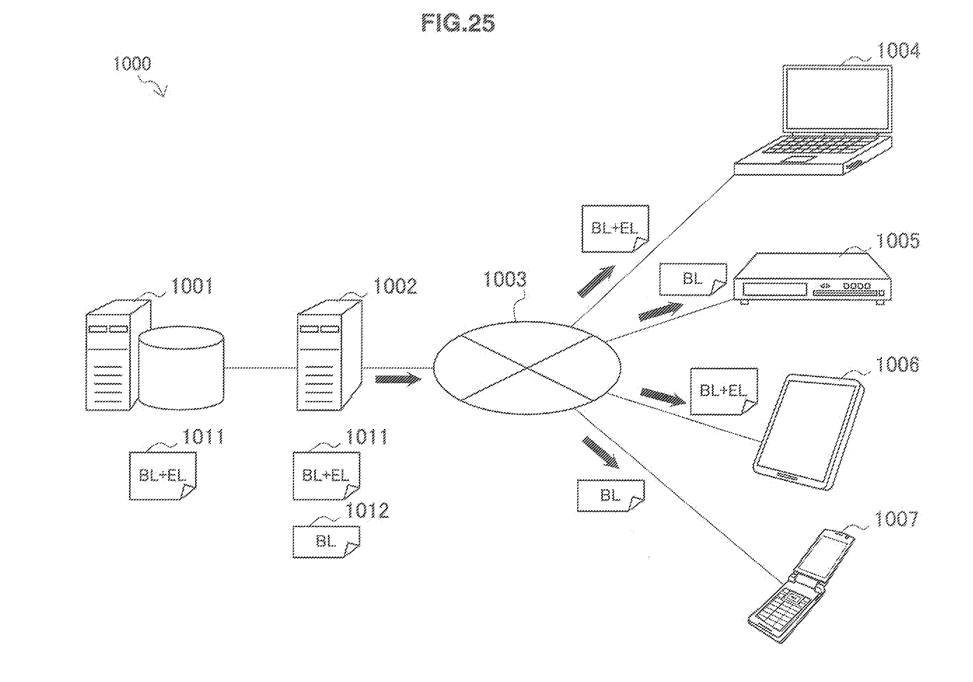

In the first example, scalable video coding is used for selective transmission of data. Referring to FIG. 25, a data transmission system 1000 includes a stream storage device 1001 and a delivery server 1002. The delivery server 1002 is connected to some terminal devices via a network 1003. The network 1003 may be a wire network or a wireless network or a combination thereof. FIG. 25 shows a PC (Personal Computer) 1004, an AV device 1005, a tablet device 1006, and a mobile phone 1007 as examples of the terminal devices.

The stream storage device 1001 stores, for example, stream data 1011 including a multiplexed stream generated by the image encoding device 10. The multiplexed stream includes an encoded stream of the base layer (BL) and an encoded stream of an enhancement layer (EL). The delivery server 1002 reads the stream data 1011 stored in the stream storage device 1001 and delivers at least a portion of the read stream data 1011 to the PC 1004, the AV device 1005, the tablet device 1006, and the mobile phone 1007 via the network 1003.

When a stream is delivered to a terminal device, the delivery server 1002 selects the stream to be delivered based on some condition such as capabilities of a terminal device or the communication environment. For example, the delivery server 1002 may avoid a delay in a terminal device or an occurrence of overflow or overload of a processor by not delivering an encoded stream having high image quality exceeding image quality that can be handled by the terminal device. The delivery server 1002 may also avoid occupation of communication bands of the network 1003 by not delivering an encoded stream having high image quality. On the other hand, when there is no risk to be avoided or it is considered to be appropriate based on a user's contract or some condition, the delivery server 1002 may deliver an entire multiplexed stream to a terminal device.

In the example of FIG. 25, the delivery server 1002 reads the stream data 1011 from the stream storage device 1001. Then, the delivery server 1002 delivers the stream data 1011 directly to the PC 1004 having high processing capabilities. Because the AV device 1005 has low processing capabilities, the delivery server 1002 generates stream data 1012 containing only an encoded stream of the base layer extracted from the stream data 1011 and delivers the stream data 1012 to the AV device 1005. The delivery server 1002 delivers the stream data 1011 directly to the tablet device 1006 capable of communication at a high communication rate. Because the mobile phone 1007 can communicate at a low communication rate, the delivery server 1002 delivers the stream data 1012 containing only an encoded stream of the base layer to the mobile phone 1007.

By using the multiplexed stream in this manner, the amount of traffic to be transmitted can adaptively be adjusted. The code amount of the stream data 1011 is reduced when compared with a case when each layer is individually encoded and thus, even if the whole stream data 1011 is delivered, the load on the network 1003 can be lessened. Further, memory resources of the stream storage device 1001 are saved.

Hardware performance of the terminal devices is different from device to device. In addition, capabilities of applications run on the terminal devices are diverse. Further, communication capacities of the network 1003 are varied. Capacities available for data transmission may change every moment due to other traffic. Thus, before starting delivery of stream data, the delivery server 1002 may acquire terminal information about hardware performance and application capabilities of terminal devices and network information about communication capacities of the network 1003 through signaling with the delivery destination terminal device. Then, the delivery server 1002 can select the stream to be delivered based on the acquired information.

Incidentally, the layer to be decoded may be extracted by the terminal device. For example, the PC 1004 may display a base layer image extracted and decoded from a received multiplexed stream on the screen thereof. After generating the stream data 1012 by extracting an encoded stream of the base layer from a received multiplexed stream, the PC 1004 may cause a storage medium to store the stream data 1012 or transfer the stream data to another device.

The configuration of the data transmission system 1000 shown in FIG. 25 is only an example. The data transmission system 1000 may include any numbers of the stream storage device 1001, the delivery server 1002, the network 1003, and terminal devices.

### (2) Second Example

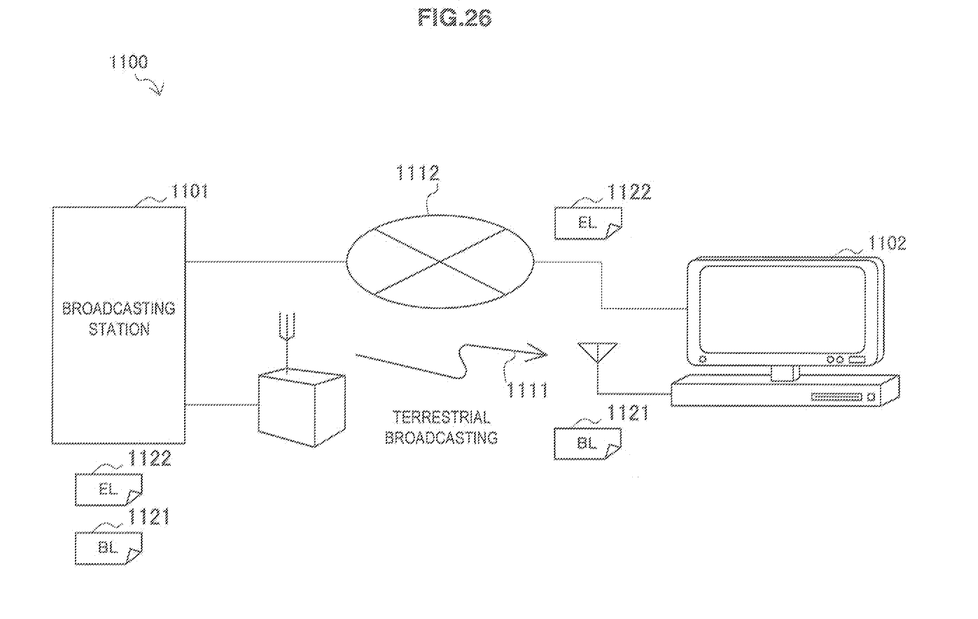

In the second example, scalable video coding is used for transmission of data via a plurality of communication channels. Referring to FIG. 26, a data transmission system 1100 includes a broadcasting station 1101 and a terminal device 1102. The broadcasting station 1101 broadcasts an encoded stream 1121 of the base layer on a terrestrial channel 1111. The broadcasting station 1101 also broadcasts an encoded stream 1122 of an enhancement layer to the terminal device 1102 via a network 1112.

The terminal device 1102 has a receiving function to receive terrestrial broadcasting broadcast by the broadcasting station 1101 and receives the encoded stream 1121 of the base layer via the terrestrial channel 1111. The terminal device 1102 also has a communication function to communicate with the broadcasting station 1101 and receives the encoded stream 1122 of an enhancement layer via the network 1112.

After receiving the encoded stream 1121 of the base layer, for example, in response to user's instructions, the terminal device 1102 may decode a base layer image from the received encoded stream 1121 and display the base layer image on the screen. Alternatively, the terminal device 1102 may cause a storage medium to store the decoded base layer image or transfer the base layer image to another device.

After receiving the encoded stream 1122 of an enhancement layer via the network 1112, for example, in response to user's instructions, the terminal device 1102 may generate a multiplexed stream by multiplexing the encoded stream 1121 of the base layer and the encoded stream 1122 of an enhancement layer. The terminal device 1102 may also decode an enhancement image from the encoded stream 1122 of an enhancement layer to display the enhancement image on the screen. Alternatively, the terminal device 1102 may cause a storage medium to store the decoded enhancement layer image or transfer the enhancement layer image to another device.

As described above, an encoded stream of each layer contained in a multiplexed stream can be transmitted via a different communication channel for each layer. Accordingly, a communication delay or an occurrence of overflow can be reduced by distributing loads on individual channels.

The communication channel to be used for transmission may dynamically be selected in accordance with some condition. For example, the encoded stream 1121 of the base layer whose data amount is relatively large may be transmitted via a communication channel having a wider bandwidth and the encoded stream 1122 of an enhancement layer whose data amount is relatively small may be transmitted via a communication channel having a narrower bandwidth. The communication channel on which the encoded stream 1122 of a specific layer is transmitted may be switched in accordance with the bandwidth of the communication channel. Accordingly, the load on individual channels can be lessened more effectively.

The configuration of the data transmission system 1100 shown in FIG. 26 is only an example. The data transmission system 1100 may include any numbers of communication channels and terminal devices. The configuration of the system described here may also be applied to other uses than broadcasting.

### (3) Third Example

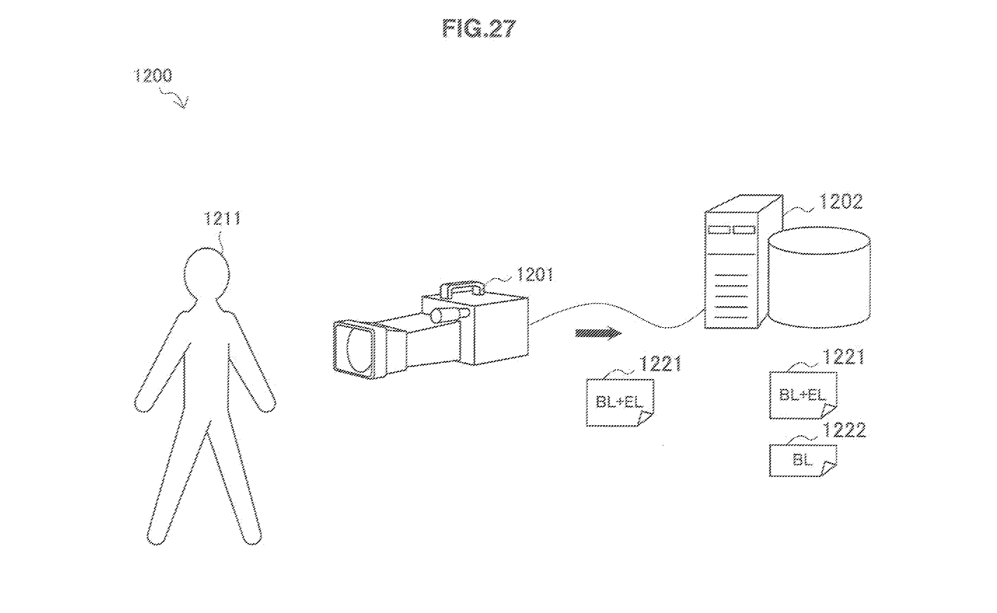

In the third example, scalable video coding is used for storage of video. Referring to FIG. 27, a data transmission system 1200 includes an imaging device 1201 and a stream storage device 1202. The imaging device 1201 scalable-encodes image data generated by a subject 1211 being imaged to generate a multiplexed stream 1221. The multiplexed stream 1221 includes an encoded stream of the base layer and an encoded stream of an enhancement layer. Then, the imaging device 1201 supplies the multiplexed stream 1221 to the stream storage device 1202.

The stream storage device 1202 stores the multiplexed stream 1221 supplied from the imaging device 1201 in different image quality for each mode. For example, the stream storage device 1202 extracts the encoded stream 1222 of the base layer from the multiplexed stream 1221 in normal mode and stores the extracted encoded stream 1222 of the base layer. In high quality mode, by contrast, the stream storage device 1202 stores the multiplexed stream 1221 as it is. Accordingly, the stream storage device 1202 can store a high-quality stream with a large amount of data only when recording of video in high quality is desired. Therefore, memory resources can be saved while the influence of image degradation on users is curbed.

For example, the imaging device 1201 is assumed to be a surveillance camera. When no surveillance object (for example, no intruder) appears in a captured image, the normal mode is selected. In this case, the captured image is likely to be unimportant and priority is given to the reduction of the amount of data so that the video is recorded in low image quality (that is, only the encoded stream 1222 of the base layer is stored). In contract, when a surveillance object (for example, the subject 1211 as an intruder) appears in a captured image, the high-quality mode is selected. In this case, the captured image is likely to be important and priority is given to high image quality so that the video is recorded in high image quality (that is, the multiplexed stream 1221 is stored).

In the example of FIG. 27, the mode is selected by the stream storage device 1202 based on, for example, an image analysis result. However, the present embodiment is not limited to such an example and the imaging device 1201 may select the mode. In the latter case, imaging device 1201 may supply the encoded stream 1222 of the base layer to the stream storage device 1202 in normal mode and the multiplexed stream 1221 to the stream storage device 1202 in high-quality mode.

Selection criteria for selecting the mode may be any criteria. For example, the mode may be switched in accordance with the loudness of voice acquired through a microphone or the waveform of voice. The mode may also be switched periodically. Also, the mode may be switched in response to user's instructions. Further, the number of selectable modes may be any number as long as the number of hierarchized layers is not exceeded.

The configuration of the data transmission system 1200 shown in FIG. 27 is only an example. The data transmission system 1200 may include any number of the imaging device 1201. The configuration of the system described here may also be applied to other uses than the surveillance camera.

[7-3. Others]

(1) Application to the Multi-View Codec

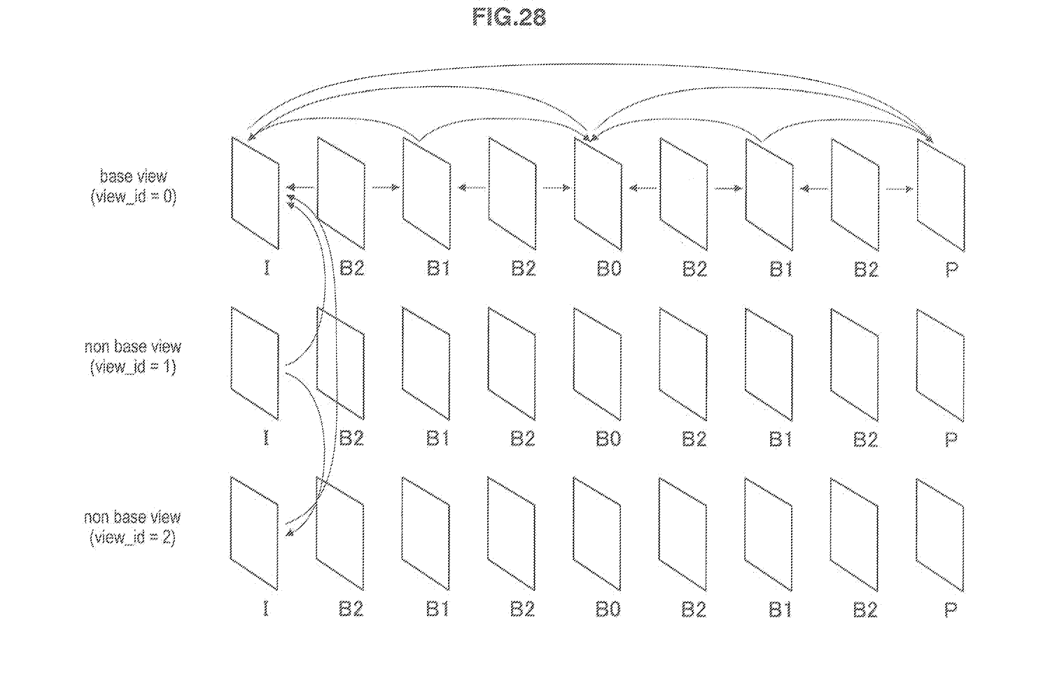

The multi-view codec is an image encoding system to encode and decode so-called multi-view video. FIG. 28 is an explanatory view illustrating a multi-view codec. Referring to FIG. 28, sequences of three view frames captured from three viewpoints are shown. A view ID (view_id) is attached to each view. Among a plurality of these views, one view is specified as the base view. Views other than the base view are called non-base views. In the example of FIG. 28, the view whose view ID is “0” is the base view and two views whose view ID is “1” or “2” are non-base views.

When multi-view image data is encoded or decoded, the code amount as a whole can be reduced by, according to technology in the present disclosure, selecting the prediction mode for a non-base view based on the prediction mode specified for a base view. Accordingly, like the case of scalable video coding, the encoding efficiency can further be enhanced also in multi-view codec.

(2) Application to Streaming Technology

Technology in the present disclosure may also be applied to a streaming protocol. In MPEG-DASH (Dynamic Adaptive Streaming over HTTP), for example, a plurality of encoded streams having mutually different parameters such as the resolution is prepared by a stream server in advance. Then, the streaming server dynamically selects appropriate data for streaming from the plurality of encoded streams and delivers the selected data. In such a streaming protocol, a prediction mode for another encoded stream may be selected based on the prediction mode specified for one encoded stream.

### 8. Summary

Heretofore, the image encoding device 10 and the image decoding device 60 according to an embodiment have been described using FIGS. 1 to 28. According to the above embodiment, when a plurality of layers is encoded by different image encoding methods in scalable video coding, a prediction mode for a second block in an enhancement layer corresponding to a first block is selected based on the prediction mode selected for the first block in a base layer. Therefore, the code amount needed for prediction mode information of the enhancement layer can be reduced and the encoding efficiency can be enhanced.

Also, according to the above embodiment, prediction modes in a second prediction mode set corresponding to prediction modes in a first prediction mode set that are not selected for the first block are excluded from the selection of the second block. Therefore, prediction mode candidates for the enhancement layer can be narrowed down. Accordingly, the number bits allocated to prediction mode information can be reduced.

Also, according to the above embodiment, not only the prediction mode corresponding to the prediction mode selected for the first block, but also prediction modes in the second prediction mode set having no corresponding prediction modes in the first prediction mode set are included in prediction mode candidates. Therefore, the possibility of use of prediction modes contained only in the second prediction mode set supported in the enhancement layer exists. Accordingly, higher prediction precision can be achieved while the code amount needed for prediction mode information being reduced.

Also, according to the above embodiment, when a prediction mode based on spatial correlations of image is selected for the first block, a prediction mode based on spatial correlations of image is selected for the second block. Similarly, when a prediction mode based on temporal correlations of image is selected for the first block, a prediction mode based on temporal correlations of image is selected for the second block. Therefore, the code amount needed for prediction mode information can effectively be reduced by utilizing correlation characteristics of image common between layers.

Mainly described herein is the example where the various pieces of information such as the information related to intra prediction and the information related to inter prediction are multiplexed to the header of the encoded stream and transmitted from the encoding side to the decoding side. The method of transmitting these pieces of information however is not limited to such example. For example, these pieces of information may be transmitted or recorded as separate data associated with the encoded bit stream without being multiplexed to the encoded bit stream. Here, the term “association” means to allow the image included in the bit stream (may be a part of the image such as a slice or a block) and the information corresponding to the current image to establish a link when decoding. Namely, the information may be transmitted on a different transmission path from the image (or the bit stream). The information may also be recorded in a different recording medium (or a different recording area in the same recording medium) from the image (or the bit stream). Furthermore, the information and the image (or the bit stream) may be associated with each other by an arbitrary unit such as a plurality of frames, one frame, or a portion within a frame.

The preferred embodiments of the present disclosure have been described above with reference to the accompanying drawings, whilst the present disclosure is not limited to the above examples, of course. A person skilled in the art may find various alternations and modifications within the scope of the appended claims, and it should be understood that they will naturally come under the technical scope of the present disclosure.

Additionally, the present technology may also be configured as below.

(1)

An image processing apparatus including:

a base layer prediction section that generates a predicted image for a first block in a base layer decoded by a first encoding method in a prediction mode specified by prediction mode information from a first prediction mode set; and

an enhancement layer prediction section that generates the predicted image for a second block corresponding to the first block in an enhancement layer decoded by a second encoding method having a second prediction mode set that is different from the first prediction mode set in a prediction mode selected from the second prediction mode set based on the prediction mode specified for the first block.

(2)

The image processing apparatus according to (1), wherein the enhancement layer prediction section excludes the prediction modes in the second prediction mode set corresponding to the prediction modes in the first prediction mode set that are not specified for the first block from a selection for the second block.

(3)

The image processing apparatus according to (2), wherein the enhancement layer prediction section selects the prediction mode specified by the prediction mode information for the second block from the prediction mode in the second prediction mode set corresponding to the prediction mode selected for the first block and prediction modes having no corresponding prediction mode in the first prediction mode set.

(4)

The image processing apparatus according to any one of (1) to (3), wherein the first prediction mode set and the second prediction mode set are prediction mode sets for an intra prediction.

(5)

The image processing apparatus according to (4),

wherein the first prediction mode set contains a DC prediction mode and does not contain a planar prediction mode,

wherein the second prediction mode set contains the DC prediction mode and the planar prediction mode, and

wherein, when the DC prediction mode is specified for the first block, the enhancement layer prediction section selects the prediction mode specified for the second block from the DC prediction mode and the planar prediction mode.

(6)

The image processing apparatus according to (4),

wherein the first prediction mode set contains a DC prediction mode and a planar prediction mode,

wherein the second prediction mode set contains the DC prediction mode and the planar prediction mode, and

wherein, when one of the DC prediction mode and the planar prediction mode is specified for the first block, the enhancement layer prediction section selects one of the DC prediction mode and the planar prediction mode for the second block.

(7)

The image processing apparatus according to any one of (4) to (6),

wherein the first prediction mode set contains a plurality of prediction modes corresponding to a plurality of prediction directions,

wherein the second prediction mode set contains a plurality of prediction modes corresponding to more of the prediction directions than the first prediction mode set, and

wherein the enhancement layer prediction section selects for the second block one of one or more of the prediction modes corresponding to a prediction direction narrowed down to within a range close to a prediction direction of the prediction mode specified for the first block.

(8)

The image processing apparatus according to (7), further including:

a decoding section that decodes a parameter indicating a difference of the prediction direction from an encoded stream of the enhancement layer,

wherein the enhancement layer prediction section selects the prediction mode corresponding to the prediction direction determined by using the prediction direction of the prediction mode specified for the first block and the difference of the prediction direction indicated by the parameter.

(9)

The image processing apparatus according to any one of (4) to (8),

wherein the first prediction mode set does not contain a luminance based color difference prediction mode,

wherein the second prediction mode set contains the luminance based color difference prediction mode, and

wherein the enhancement layer prediction section selects the prediction mode specified for the second block from the prediction mode specified for the first block and the luminance based color difference prediction mode.

(10)

The image processing apparatus according to any one of (1) to (3), wherein the first prediction mode set and the second prediction mode set are prediction mode sets for an inter prediction.

(11)

The image processing apparatus according to (10), wherein the enhancement layer prediction section selects the prediction mode based on a spatial correlation of an image for the second block when the prediction mode based on the spatial correlation of the image is selected for the first block and selects the prediction mode based on a temporal correlation of the image for the second block when the prediction mode based on the temporal correlation of the image is selected for the first block.

(12)

The image processing apparatus according to (11),

wherein the first prediction mode set contains a space direct mode,

wherein the second prediction mode set contains a space merge mode and a spatial motion vector prediction mode, and

wherein, when the space direct mode is specified for the first block, the enhancement layer prediction section selects the prediction mode specified for the second block from the space merge mode and the spatial motion vector prediction mode.

(13)

The image processing apparatus according to (11) or (12),

wherein the first prediction mode set contains a time direct mode,

wherein the second prediction mode set contains a time merge mode and a temporal motion vector prediction mode, and

wherein, when the time direct mode is specified for the first block, the enhancement layer prediction section selects the prediction mode specified for the second block from the time merge mode and the temporal motion vector prediction mode.

(14)

The image processing apparatus according to (10),

wherein the first encoding method is advanced video coding (AVC),

wherein the second encoding method is high efficiency video coding (HEVC), and

wherein, when a direct mode or a skip mode is specified for the first block, the enhancement layer prediction section selects a merge mode for the second block.

(15)

The image processing apparatus according to (10),

wherein the first encoding method is advanced video coding (AVC),

wherein the second encoding method is high efficiency video coding (HEVC), and

wherein, when the prediction mode other than a direct mode and a skip mode is specified for the first block, the enhancement layer prediction section selects a motion vector prediction mode for the second block.

(16)

The image processing apparatus according to any one of (10) to (15),

wherein the base layer prediction section makes the inter prediction for the first block according to a reference direction selected from an L0 prediction, an L1 prediction, and a bidirectional prediction, and

wherein the enhancement layer prediction section makes the inter prediction for the second block according to the reference direction used for the first block.

(17)

An image processing method including:

generating a predicted image for a first block in a base layer decoded by a first encoding method in a prediction mode specified by prediction mode information from a first prediction mode set; and

generating the predicted image for a second block corresponding to the first block in an enhancement layer decoded by a second encoding method having a second prediction mode set that is different from the first prediction mode set in the prediction mode selected from the second prediction mode set based on the prediction mode specified for the first block.

(18)

An image processing apparatus including:

a base layer prediction section that generates a predicted image for a first block in a base layer encoded by a first encoding method in an optimum prediction mode selected from a first prediction mode set; and

an enhancement layer prediction section that generates the predicted image for a second block corresponding to the first block in an enhancement layer encoded by a second encoding method having a second prediction mode set that is different from the first prediction mode set in the prediction mode selected from the second prediction mode set based on the prediction mode selected for the first block.

(19)

An image processing method including:

generating a predicted image for a first block in a base layer encoded by a first encoding method in an optimum prediction mode selected from a first prediction mode set; and

generating the predicted image for a second block corresponding to the first block in an enhancement layer encoded by a second encoding method having a second prediction mode set that is different from the first prediction mode set in the prediction mode selected from the second prediction mode set based on the prediction mode selected for the first block.

Additionally, the configuration described below is included in the technical scope of the present disclosure.

(1)

An image processing apparatus including:

a base layer prediction section that generates a predicted image for a first block in a base layer decoded by a first encoding method by making an inter prediction using a first motion vector, and

an enhancement layer prediction section that generates the predicted image for a second block corresponding to the first block in an enhancement layer decoded by a second encoding method by making the inter prediction in a prediction mode from a prediction mode set for the inter prediction of the second encoding method corresponding to a predicted motion vector showing a smallest difference from the first motion vector.

(2)

The image processing apparatus according to (1), wherein the enhancement layer prediction section evaluates the difference between the first motion vector scaled in accordance with a resolution ratio between the base layer and the enhancement layer and the predicted motion vector corresponding to each of the prediction modes of the prediction mode set.

(3)

The image processing apparatus according to (1) or (2), wherein when a plurality of the prediction modes corresponding to the predicted motion vector showing the smallest difference from the first motion vector is present, the prediction mode having a same reference index as a reference index corresponding to the first motion vector in the base layer for the inter prediction of the enhancement layer.

(4)

The image processing apparatus according to (3), wherein when the plurality of prediction modes corresponding to the predicted motion vector showing the smallest difference from the first motion vector is present and also a number of the prediction modes having the same reference index as the reference index corresponding to the first motion vector in the base layer is not one, the prediction mode with a smallest reference index of the plurality of prediction modes is selected for the inter prediction of the enhancement layer.

(5)

The image processing apparatus according to (1) or (2), wherein when a plurality of the prediction modes corresponding to the predicted motion vector showing the smallest difference from the first motion vector is present, the prediction mode indicated by a parameter decoded from an encoded stream of the enhancement layer is selected for the inter prediction of the enhancement layer.

(6)

The image processing apparatus according to any one of (1) to (5), wherein the enhancement layer prediction section evaluates the difference between the first motion vector scaled based on the difference of the reference index between the base layer and the enhancement layer and the predicted motion vector of each of the prediction modes of the prediction mode set.

(7)

The image processing apparatus according to any one of (1) to (6), wherein

the first encoding method is a method from AVC (Advanced Video Coding) and HEVC (High Efficiency Video Coding) indicated by a flag decoded from the encoded stream,

the second encoding method is HEVC, and

when the flag indicates AVC, the enhancement layer prediction section makes the inter prediction in the prediction mode decoded from the encoded stream of the enhancement layer without referring to motion information of the first block.

(8)

The image processing apparatus according to any one of (1) to (7), wherein when an intra prediction is made for a third block in the base layer by the base layer prediction section, the enhancement layer prediction section generates the predicted image by making the intra prediction for a fourth block corresponding to the third block in the enhancement layer.

(9)

The image processing apparatus according to any one of (1) to (7), wherein when an intra prediction is made for a third block in the base layer by the base layer prediction section, the enhancement layer prediction section makes the inter prediction for a fourth block corresponding to the third block in the enhancement layer using the motion information decoded from the encoded stream of the enhancement layer.

(10)

An image processing method including:

generating a predicted image for a first block in a base layer decoded by a first encoding method by making an inter prediction using a first motion vector; and

generating the predicted image for a second block corresponding to the first block in an enhancement layer decoded by a second encoding method by making the inter prediction in a prediction mode from a prediction mode set for the inter prediction of the second encoding method corresponding to a predicted motion vector showing a smallest difference from the first motion vector.

(11)

An image processing apparatus including:

a base layer prediction section that generates a predicted image for a first block in a base layer encoded by a first encoding method by making an inter prediction using a first motion vector, and

an enhancement layer prediction section that generates the predicted image for a second block corresponding to the first block in an enhancement layer encoded by a second encoding method by making the inter prediction in a prediction mode from a prediction mode set for the inter prediction of the second encoding method corresponding to a predicted motion vector showing a smallest difference from the first motion vector.

(12)

An image processing method including:

generating a predicted image for a first block in a base layer encoded by a first encoding method by making an inter prediction using a first motion vector; and

generating the predicted image for a second block corresponding to the first block in an enhancement layer encoded by a second encoding method by making the inter prediction in a prediction mode from a prediction mode set for the inter prediction of the second encoding method corresponding to a predicted motion vector showing a smallest difference from the first motion vector.

### REFERENCE SIGNS LIST

10 image encoding device (image processing apparatus)
30a intra prediction section (base layer prediction section)
30b intra prediction section (enhancement layer prediction section)
40a inter prediction section (base layer prediction section)
40b inter prediction section (enhancement layer prediction section)
60 image decoding device (image processing apparatus)
80a intra prediction section (base layer prediction section)
80b intra prediction section (enhancement layer prediction section)
90a inter prediction section (base layer prediction section)
90b inter prediction section (enhancement layer prediction section)

1. An image processing apparatus comprising:
a base layer prediction section that generates a predicted image for a first block in a base layer decoded by a first encoding method in a prediction mode specified by prediction mode information from a first prediction mode set; and
an enhancement layer prediction section that generates the predicted image for a second block corresponding to the first block in an enhancement layer decoded by a second encoding method having a second prediction mode set that is different from the first prediction mode set in a prediction mode selected from the second prediction mode set based on the prediction mode specified for the first block.

2. The image processing apparatus according to claim 1, wherein the enhancement layer prediction section excludes the prediction modes in the second prediction mode set corresponding to the prediction modes in the first prediction mode set that are not specified for the first block from a selection for the second block.

3. The image processing apparatus according to claim 2, wherein the enhancement layer prediction section selects the prediction mode specified by the prediction mode information for the second block from the prediction mode in the second prediction mode set corresponding to the prediction mode selected for the first block and prediction modes having no corresponding prediction mode in the first prediction mode set.

4. The image processing apparatus according to claim 1, wherein the first prediction mode set and the second prediction mode set are prediction mode sets for an intra prediction.

5. The image processing apparatus according to claim 4,
wherein the first prediction mode set contains a DC prediction mode and does not contain a planar prediction mode,
wherein the second prediction mode set contains the DC prediction mode and the planar prediction mode, and
wherein, when the DC prediction mode is specified for the first block, the enhancement layer prediction section selects the prediction mode specified for the second block from the DC prediction mode and the planar prediction mode.

6. The image processing apparatus according to claim 4,
wherein the first prediction mode set contains a DC prediction mode and a planar prediction mode,
wherein the second prediction mode set contains the DC prediction mode and the planar prediction mode, and
wherein, when one of the DC prediction mode and the planar prediction mode is specified for the first block, the enhancement layer prediction section selects one of the DC prediction mode and the planar prediction mode for the second block.

7. The image processing apparatus according to claim 4,
wherein the first prediction mode set contains a plurality of prediction modes corresponding to a plurality of prediction directions,
wherein the second prediction mode set contains a plurality of prediction modes corresponding to more of the prediction directions than the first prediction mode set, and
wherein the enhancement layer prediction section selects for the second block one of one or more of the prediction modes corresponding to a prediction direction narrowed down to within a range close to a prediction direction of the prediction mode specified for the first block.

8. The image processing apparatus according to claim 7, further comprising:
a decoding section that decodes a parameter indicating a difference of the prediction direction from an encoded stream of the enhancement layer,
wherein the enhancement layer prediction section selects the prediction mode corresponding to the prediction direction determined by using the prediction direction of the prediction mode specified for the first block and the difference of the prediction direction indicated by the parameter.

9. The image processing apparatus according to claim 4,
wherein the first prediction mode set does not contain a luminance based color difference prediction mode,
wherein the second prediction mode set contains the luminance based color difference prediction mode, and
wherein the enhancement layer prediction section selects the prediction mode specified for the second block from the prediction mode specified for the first block and the luminance based color difference prediction mode.

10. The image processing apparatus according to claim 1, wherein the first prediction mode set and the second prediction mode set are prediction mode sets for an inter prediction.

11. The image processing apparatus according to claim 10, wherein the enhancement layer prediction section selects the prediction mode based on a spatial correlation of an image for the second block when the prediction mode based on the spatial correlation of the image is selected for the first block and selects the prediction mode based on a temporal correlation of the image for the second block when the prediction mode based on the temporal correlation of the image is selected for the first block.

12. The image processing apparatus according to claim 11,
wherein the first prediction mode set contains a space direct mode,
wherein the second prediction mode set contains a space merge mode and a spatial motion vector prediction mode, and
wherein, when the space direct mode is specified for the first block, the enhancement layer prediction section selects the prediction mode specified for the second block from the space merge mode and the spatial motion vector prediction mode.

13. The image processing apparatus according to claim 11,
wherein the first prediction mode set contains a time direct mode,
wherein the second prediction mode set contains a time merge mode and a temporal motion vector prediction mode, and
wherein, when the time direct mode is specified for the first block, the enhancement layer prediction section selects the prediction mode specified for the second block from the time merge mode and the temporal motion vector prediction mode.

14. The image processing apparatus according to claim 10,
wherein the first encoding method is advanced video coding (AVC),
wherein the second encoding method is high efficiency video coding (HEVC), and
wherein, when a direct mode or a skip mode is specified for the first block, the enhancement layer prediction section selects a merge mode for the second block.

15. The image processing apparatus according to claim 10,
wherein the first encoding method is advanced video coding (AVC),
wherein the second encoding method is high efficiency video coding (HEVC), and
wherein, when the prediction mode other than a direct mode and a skip mode is specified for the first block, the enhancement layer prediction section selects a motion vector prediction mode for the second block.

16. The image processing apparatus according to claim 10,
wherein the base layer prediction section makes the inter prediction for the first block according to a reference direction selected from an L0 prediction, an L1 prediction, and a bidirectional prediction, and
wherein the enhancement layer prediction section makes the inter prediction for the second block according to the reference direction used for the first block.

17. An image processing method comprising:
generating a predicted image for a first block in a base layer decoded by a first encoding method in a prediction mode specified by prediction mode information from a first prediction mode set; and
generating the predicted image for a second block corresponding to the first block in an enhancement layer decoded by a second encoding method having a second prediction mode set that is different from the first prediction mode set in the prediction mode selected from the second prediction mode set based on the prediction mode specified for the first block.

18. An image processing apparatus comprising:
a base layer prediction section that generates a predicted image for a first block in a base layer encoded by a first encoding method in an optimum prediction mode selected from a first prediction mode set; and
an enhancement layer prediction section that generates the predicted image for a second block corresponding to the first block in an enhancement layer encoded by a second encoding method having a second prediction mode set that is different from the first prediction mode set in the prediction mode selected from the second prediction mode set based on the prediction mode selected for the first block.

19. An image processing method comprising:
generating a predicted image for a first block in a base layer encoded by a first encoding method in an optimum prediction mode selected from a first prediction mode set; and
generating the predicted image for a second block corresponding to the first block in an enhancement layer encoded by a second encoding method having a second prediction mode set that is different from the first prediction mode set in the prediction mode selected from the second prediction mode set based on the prediction mode selected for the first block.
